(19) United States
(12) Patent Application Publication
(10) Pub. No.: US 2020/0209838 A1
(43) Pub. Date: Jul. 2, 2020

(54) SYSTEM AND METHOD FOR SUPPORTING PRODUCTION MANAGEMENT

(71) Applicant: Hitachi, Ltd.

(72) Inventors: Kenichirou KAWAKAMI, Tokyo (JP); Daisuke KOMAKI, Tokyo (JP); Toshihiko KASHIYAMA, Tokyo (JP); Yuncheng ZHU, Tokyo (JP); Kazuaki YAMAGISHI, Tokyo (JP); Shigeyasu KUBO, Tokyo (JP); Takanori MORITOMO, Tokyo (JP)

(21) Appl. No.: 16/335,315

(22) PCT Filed: Jul. 30, 2018
(86) PCT No.: PCT/JP2018/028509

§ 371 Date: Mar. 21, 2019

(30) Foreign Application Priority Data
Sep. 26, 2017 (JP) 2017-184630

(51) Int. Cl. G05B 19/418

(52) U.S. Cl. CPC G05B 19/41875; G05B 19/41885; G05B 19/4183

(57) ABSTRACT

A production management supporting system analyzes past record information including information showing, for each product loaded in a production line in which a plurality of steps are performed, an execution time of each of the steps on the basis of one or more attentional perspectives to detect, from among objects displayed on a diagram chart showing a production situation, display objects each satisfying one or more requirements associated with the one or more attentional perspectives. The production management supporting system performs accentuated display of at least one of the detected display objects.

### TECHNICAL FIELD

The present invention relates generally to a computer technique for supporting production management.

### BACKGROUND ART

In production, it is common to sequentially load a plurality of products into a production line and sequentially perform a plurality of steps on each of the products. In general, it is desirable to bring as many products as possible into a shippable state per unit time so that products are successively loaded into a production line in a short period of time. This results in numerous management targets and therefore a heavy burden on production management for recognizing an abnormality occurring in a production process in the production line and reliably preventing shipment of defective products.

As a means for reducing the burden, the technique disclosed in PTL 1 is known. In the technique disclosed in PTL 1, ideal data is calculated in advance for each step in a production line, a comparison is made between a graph (hereinafter referred to as an ideal graph) based on the ideal data and a graph (hereinafter referred to as a past record graph) based on past record data resulting from actual measurement performed for each step, and the difference between the two graphs is displayed on the past record graph.

### CITATION LIST

### Patent Literature

[PTL 1] Japanese Patent Application Laid-open No. 2015-108904

### SUMMARY OF INVENTION

### Technical Problem

However, it is not easy to calculate the ideal data in advance.

In addition, calculated ideal data is not necessarily accurate. Consequently, it is conceivably highly probable that a production situation presumed from the difference between the ideal graph and the past record graph is erroneous (it is highly probable that, e.g., a product, a step, or a time considered to be subjected to the occurrence of an abnormality is actually not abnormal or, conversely, a product, a step, or a time presumed to be normal is actually abnormal).

For such reasons, it cannot be said that the technique disclosed in PTL 1 has reduced the burden on production management for recognizing an abnormality occurring in the production process in the production line and reliably preventing shipment of defective products.

### Solution to Problem

A production management supporting system analyzes past record information including information showing, for each product loaded in a production line in which a plurality of steps are performed, an execution time of each of the steps on the basis of one or more attentional perspectives to detect, among objects displayed on a diagram chart showing a production situation, display objects each satisfying one or more requirements associated with the one or more attentional perspectives. The diagram chart is a polygonal line graph having a first axis and a second axis perpendicular to the first axis The first axis corresponds to time. The second axis corresponds to the steps. The diagram chart has a polygonal line for each product for which at last one of the plurality of steps has the execution time belonging to a display target period. A point on each polygonal line corresponds to the step and to the execution time of the step. The production management supporting system performs accentuated display of at least one of the detected display objects.

### Advantageous Effects of Invention

The accentuated display of the display object on the diagram chart showing the production situation can appropriately be performed on the basis of a result of the analysis of the past record information based on the attentional perspective without preparing ideal data showing an ideal production situation in advance. As a result, it can be expected that a user promptly and precisely specifies a product presumably associated with any abnormality. This can reduce a burden on production management for recognizing an abnormality occurring in a production process in the production line and reliably preventing shipment of defective products.

### BRIEF DESCRIPTION OF DRAWINGS

FIG. 1 shows the outline of a first embodiment.

FIG. 2 shows a configuration of a production management supporting system according to the first embodiment.

FIG. 3 shows an example of functions implemented in a management server.

FIG. 4 shows a representative example of the relations among the functions.

FIG. 5 shows an example of a diagram chart screen.

FIG. 6 is a schematic diagram showing the definition of a blank region.

FIG. 7 shows a past record table.

FIG. 8 shows a defective product occurrence table.

FIG. 9 shows a facility trouble table.

FIG. 10 shows a plan suspension table.

FIG. 11 shows a facility alert table.

FIG. 12 shows an example of polygonal line accentuated display data.

FIG. 13 shows an example of blank region accentuated display data.

FIG. 14 shows an example of an attentional perspective specification UI (user interface).

FIG. 15 shows an example of display of related details.

FIG. 16 shows an example of display of product details.

FIG. 17 shows an example of display of maintenance records.

FIG. 18 shows the flow of a display control process.

FIG. 19 shows the flow of an accentuated object determining process corresponding to an attentional perspective “OCCURRENCE OF OVERTAKING”.

FIG. 20 shows an example of the past record table showing overtaking and an example of accentuated display based on the result of the process in FIG. 19.

FIG. 21 shows the flow of the accentuated object determining process corresponding to an attentional perspective “OCCURRENCE OF DEFECTIVE PRODUCT”.

FIG. 22 shows an example of the past record table showing the occurrence of a defective product and an example of the accentuated display based on the result of the process in FIG. 21.

FIG. 23 shows the flow of the accentuated object determining process corresponding to an attentional perspective “AREA OF BLANK REGION”.

FIG. 24 shows an example of the accentuated display based on the result of the process in. FIG. 23.

FIG. 25 shows the flow of the accentuated object determining process (eliminating process) corresponding to an attentional perspective “ELIMINATION OF DISPLAY OBJECT RELATED TO PLAN SUSPENSION FROM ACCENTUATED DISPLAY TARGETS”.

FIG. 26 shows the flow of the accentuated object determining process corresponding to an attentional perspective “MAGNITUDE OF SPECIFIC MEASUREMENT VALUE”.

FIG. 27 shows the flow of the accentuated object determining process corresponding to an attentional perspective “WORKER”.

FIG. 28 shows the flow of the accentuated object determining process corresponding to an attentional perspective “RELATIONSHIP WITH OCCURRENCE OF DEFECTIVE PRODUCT”.

FIG. 29 shows an example of the accentuated display based on the result of the process in FIG. 28.

FIG. 30 shows the flow of a process of determining a point of origin of the blank region as an accentuated display target.

FIG. 31 shows an example of the accentuated display of the point of origin of the blank region.

FIG. 32 shows an example of a diagram chart to which event display control according to a second embodiment is applied.

FIG. 33 shows a portion of an example of functions implemented in the second embodiment including the function associated with the difference from the first embodiment.

FIG. 34 shows an event list table.

FIG. 35 shows the flow of as event display control process.

FIG. 36 shows an example of the diagram chart in a third embodiment.

### DESCRIPTION OF EMBODIMENTS

The following will describe some of the embodiments of the present invention.

In the following description, an “interface portion” includes one or more interfaces. The one or more interfaces may include at least one of a user interface portion and a communication interface portion. The user interface portion may include at least one I/O device among one or more I/O devices (e.g., input devices (e.g., a keyboard and a pointing device) and an output device (e.g., a display device)) and a display computer or may include an interface device for the at least one I/O device. The communication interface portion may include one or more communication interface devices. The one or more communication interface devices may be one or more communication interface devices of the same type (i.e., one or more NICs (Network interface Cards)) or two or more communication interface devices of different types (e.g., a NIC and an HBA (Host Bus Adapter)).

In the following description, a “storing portion” includes one or more memories. At least one of the memories associated with the storing portion may appropriately be a volatile memory. The storing portion is used mainly during a process performed by the processor portion. The storing portion may also include, in addition to the memories, one or more nonvolatile storing devices (e.g., HDD (Hard Disk Drives) or SSDs (Solid State Drives)).

In the following description, the “processor portion” includes one or more processors. At least one of the processors is typically a microprocessor such as a CPU (Central Processing Unit), but the processors may also include a processor of another type such as GPU (Graphics Processing Unit). Each of the one or more processors may be a single-core processor or a multi-core processor. The processors may also include a hardware circuit which performs a part or the whole of a process.

In the following description, a process may be described using a “program” as a subject. Since a program performs a determined process by being executed by the processor portion, while appropriately using the storing portion (e.g., memory), the interface portion (e.g., communication port), and/or the like, the subject of the processor may also be the processor. The process described using the program as the subject may also be a process performed by the processor portion or an apparatus having the processor portion. The processor portion may also include a hardware circuit (e.g., FPGA (Field-Programmable Gate Array) or an ASIC (Application Specific Integrated Circuit)) which performs a part or the whole of the process. The program may also be installed from a program source to an apparatus such as a computer. The program source may be, e.g., a program distribution server or a recording medium (e.g., non-transitory recording medium) which is readable by the computer. In the following description, two or more programs may be implemented as one program or one program may be implemented as two or more programs.

In the following description, information may be described using such an expression as “a xxx table”, but the information may be expressed using any data structure. Specifically, to show that the information does not depend on any data structure, “a XXX table” can be referred to also as “XXX information”. Also, in the following description, a configuration of each table is exemplary. One table may be divided into two or more tables or all or any of two or more tables may be one table.

In the following description, a “production management supporting system” may be configured to include one or more computers. Specifically, when, e.g., a computer has a display device and displays information on the display device thereof, the computer may appropriately be the production management supporting system. Alternatively, when, e.g., a first computer (e.g., management server) transmits information to be displayed to a remote second computer (display computer (e.g., management client)) and the display computer displays the information (when the first computer displays the information on the second computer), at least the first computer of the first and second computers may appropriately be the production management supporting system. The production management supporting system may also have an interface portion, a storing portion, and a processor portion coupled to the interface portion and the storing portion. The interface portion may appropriately be at least one of a user interface portion and a communication interface portion. The user interface portion may be at least one I/O device among one or more I/O devices (e.g., input devices (e.g., a keyboard and a pointing device) and an output device (e.g., a display device)) and the second computer. The communication interface portion may appropriately be one or more communication interface devices. The “display of information to be displayed” by the computer in the production management supporting system may be the display of information to be displayed on the display device of the computer or may also be the transmission of the information to be displayed from the computer to the display computer (in the latter case, the display computer displays the information to be displayed). The function of at least one of the management server in the production management supporting system and the production management supporting system may also be implemented by a virtual computer (e.g., VM (Virtual Machine)) implemented by at least one physical computer (e.g., a physical calculation resource on a cloud basis). At least a portion of the production management supporting system may be software-defined.

A “product” generally means a produced item, i.e., a finished product. However, in the following description, the “product” means each of the items loaded in a production line. Accordingly, in the following description, the “product” may be any of an item before loaded into the production line, an item currently in the production line (i.e., “semi-finished product”), and a finished product in a shippable state through all the steps in the production line.

### First Embodiment

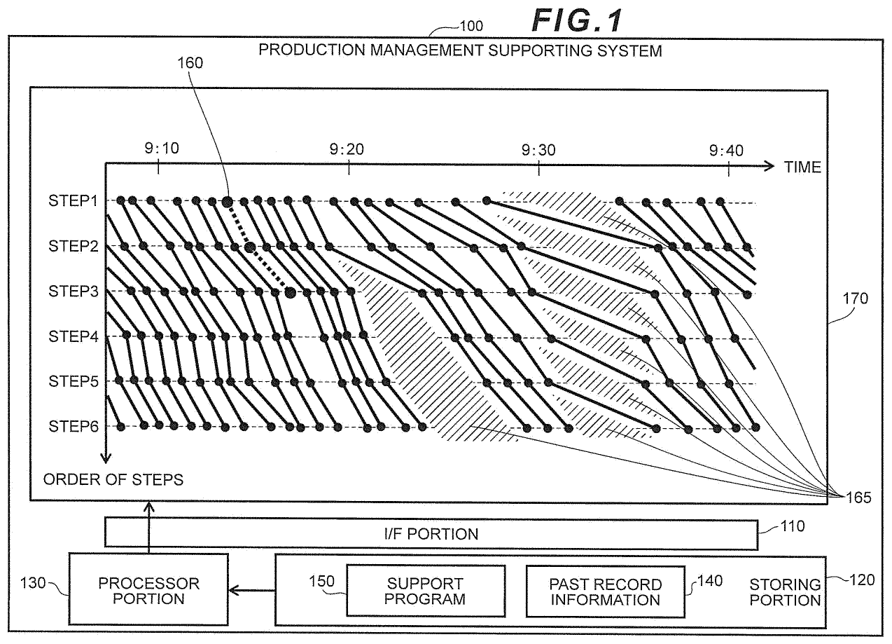

FIG. 1 shows the outline of a first embodiment.

A production management supporting system 100 has an I/F (interface) portion 110, a storing portion 120, and a processor portion 130 coupled to the I/F portion 110 and the storing portion 120. The storing portion 120 stores past record information 140 and a support program 150.

The past record information 140 include information showing the past record of production, specifically, e.g., information showing an execution time of each of steps for each product loaded in a production line. The execution time of the step may be one or more times selected between the starting time of the step and the ending time thereof in accordance with a predetermined rule. In the present embodiment, the ending time is adopted.

The support program 150 performs visualization of a production situation as one of supports for production management. Specifically, the support program 150 analyzes the past record information 140 by being executed by the processor portion 130 and displays a diagram chart 170 showing the production situation on the basis of the result of the analysis. The diagram chart 170 is a so-called polygonal line graph. In the chart 170, an abscissa axis corresponds to time, an ordinate axis corresponds to the steps, and one polygonal line corresponds to one product. A point on the polygonal line corresponds to a step for a product and to the ending time thereof.

The support program 150 analyzes the past record information 140 on the basis of one or more attentional perspectives to detect, among the objects displayed on the diagram chart 170 showing the production situation during a display target period, the display objects each satisfying one or more requirements associated with the one or more attentional perspectives. The support program 150 performs accentuated display of at least one of the detected display objects. The “attentional perspectives” are perspectives on the basis of which attention is paid with respect to the production situation. The “display objects” are the objects displayed on the diagram chart 170. The present embodiment allows the accentuated display of the display objects on the diagram chart 170 showing the production situation to be appropriately performed on the basis of the result of analyzing the past record information 140 on the basis of the attentional perspective without preparing ideal data showing an ideal production situation in advance. As a result, it can be expected that a user (e.g., a production administrator) promptly and precisely specifies a product presumably associated with any abnormal situation, while holistically recognizing the production situation. In other words, it is possible to reduce a burden on production management for recognizing an abnormality occurring in a production process in the production line and reliably preventing shipment of defective products.

Note that, as specific examples of the “situation” mentioned herein, a time block, the smooth progress of production (situation determined from a past record cycle time, a past record lead time, or the like), the state of a load on facilities, and the situation of personnel assignment can be considered.

Also, the “without preparing ideal data showing an ideal production situation in advance” shown above means that the need for the ideal data can be eliminated. No use of the ideal data is not mandatory.

As the mode of the accentuated display of the display objects, any of various adoptable modes can be adopted ((e.g. changing of a line width, changing of a color, changing of the shade of the color, changing of a pattern, blinking, display of a pop-up message, or superimposition of another object different in color or the like on the display object).

As the attentional perspective, any of various perspectives can be adopted. For example, it is assumed that, as the attentional perspective, “OCCURRENCE OF DEFECTIVE PRODUCT” is adopted. When a defective product is detected during production, a product detected as the defective product is retrieved midway from the production line so that the subsequent steps tend not to be performed on the product. In the present embodiment, in view of such a tendency, when the support program 150 specifies a product having no ending time of at least one step in the analysis of the past record information 140, the support program 150 performs accentuated display of the polygonal line (polygonal line corresponding only to any of the steps) corresponding to the product (a reference sign 160).

On the diagram chart 170, the relationship between a step and the ending time thereof is represented by a polygonal line for each product. When the flow of products becomes irregular due to a cause such as the occurrence of fluctuations in a processing period in a given step or the occurrence of product overtaking (such that a given product is removed in a given step and a product loaded later than the product flows ahead of the product), any of the blank regions on the diagram chart 170 may be unnaturally increased or reduced in size. When the irregular flow occurs frequently, numerous such blank regions are observed on the diagram chart 170.

In production management, management of a situation between steps and a situation between products in the same step is an important management item. It can be considered that at least one of the shape and size of the blank region depends on such a situation.

However, it is difficult to precisely determine, by visual inspection, whether or not each of the blank regions is a noteworthy blank region (e.g., blank region associated with any abnormal situation). For example, even when the blank region has a large size, the blank region is not necessarily the blank region associated with an abnormal situation. Conversely, even when the blank region has a small size, the blank region is not necessarily a blank region associated with a normal situation.

In addition to such a problem associated with the size of the blank region, when numerous blank regions are present on the diagram chart 170, it is significantly difficult to examine, by visual recognition, all the blank regions for whether or not the blank regions are associated with abnormal situations. Specifically, since, e.g., products are successively loaded into the production line in a short period of time as described above, there are numerous management targets. When it is attempted to holistically manage the production situation, the polygonal lines are densely arranged on the display screen of the diagram chart 170. Consequently, there are numerous blank regions which are so small that it is difficult to visually recognize the blank regions, and noteworthy blank regions may be missed.

Accordingly, in the present embodiment, each of the blank regions on the diagram chart. 170 is adopted as one of the display objects. In other words, in addition to objects actually drawn such as polygonal lines, the region between the polygonal lines in a display area, such as a plot area, is also adopted as one of the display objects. In short, the concept of the display object is expanded. In the present embodiment, the support program 150 specifies, among the plurality of blank regions on the diagram chart 170, the blank region satisfying the one or more requirements associated with the one or more attentional perspectives and performs the accentuated display of the specified blank region (e.g., a reference sign 165). Thus, the noteworthy blank region is automatically recommended. The user is allowed to preferentially examine first the details (e.g., the details of a product) of a situation (e.g., the step or time belonging to the blank region) associated with the recommended blank region (subjected to the accentuated display). As a result, it can be expected to further reduce a burden on production management for recognizing an abnormality occurring in the production process in the production line and reliably preventing shipment of defective products.

Note that the support program 150 can set the accentuation level (e.g., color shade) of the blank region as an accentuated display target to an accentuation level in accordance with at least one of items (A) to (C) shown below which are:

(A) the degree of importance of at least one of the one or more attentional perspectives on the basis of which the blank region is determined to be the accentuated display target;

(B) the number of the attentional perspectives on the basis of which the blank region is determined to be the accentuated display target; and

(C) the value (e.g., the area of the blank region or a measurement value obtained by measuring the interval between the times belonging to the blank region) obtained for the blank region on the basis of the attentional perspectives.

As a result, when the plurality of blank regions are subjected to the accentuated display, the user can promptly determine the blank region, the situation of which should preferentially be recognized first, Note that (A) and (B) are effective when, e.g., the blank region as the accentuated display target is determined on the basis of the plurality attentional perspectives (i.e., when the same blank region may be determined to be the accentuated display target on the basis of each of the plurality of attentional perspectives)). On the other hand, (C) is effective when the value calculated for the blank regions on the basis of the same attentional perspective differs from one blank region to another.

In addition, the user is allowed to specify at least one of the attentional perspectives or the degree of importance thereof. This allows the noteworthy blank region to be recommended on the basis of the perspective intended by the user.

The following will describe the present embodiment in detail.

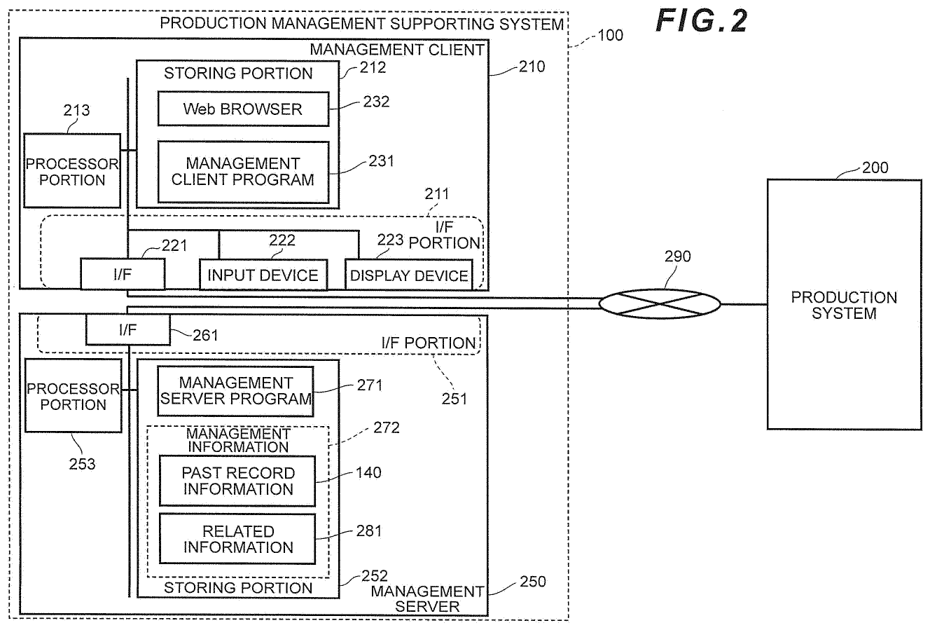

FIG. 2 shows a configuration of the production management supporting system 100.

The production management supporting system 100 includes a management server 250 and one or more management clients 210 coupled to the management server 250. To the management server 250, each of the management clients 210 and a production system. 200 is coupled via a communication network (e.g., a LAN (Local Area Network), a WAN (Wide Area Network), or the Internet) 290.

The production system 200 is a system (e.g., factory) including a production line and includes apparatuses such as, e.g., a plurality of apparatuses for a plurality of steps in the production line, a plurality of sensors which regularly perform measurement for a plurality of measurement items with regard to the plurality of steps, and a server which stores a plurality of measurement values regularly obtained using the plurality of sensors and transmits the plurality of measurement values to the management server 250. From the production system 200, information (raw data such as, e.g., production dynamic state data, facility data, and quality measurement data) is regularly or irregularly transmitted to the management server 250 and stored in the management server 250. For example, the information includes, for each product, a product ID and the ending time of each step.

The management client 210 has an I/F portion 211, a storing portion 212, and a processor portion 213 coupled to the I/F portion 211 and the storing portion 212.

The I/F portion 211 includes an I/F (communication interface device coupled to the communication network 290) 221, an input device (e.g., pointing device or keyboard) 222, and a display device (device having a physical screen which displays information) 223. A touch screen integrally including the input device 222 and the display device 223 may also be adopted.

The storing portion 212 stores a computer program executed by the processor portion 213 and information used by the processor portion 213. Specifically, for example, the storing portion 212 stores a management client program 231 and a Web browser 232. The management client program 231 communicates with the management server 250 and displays information such as the diagram chart 170 described above via the Web browser 232.

The management server 250 has an I/F portion 251, a storing portion 252, and a processor portion. 253 coupled to the I/F portion 251 and the storing portion 252.

The I/F portion 251 includes an I/F (communication interface device coupled to the communication network 290) 261.

The storing portion 252 stores a computer program executed by the processor portion. 253 and information used by the processor portion 253. Specifically, for example, the storing portion 252 stores a management server program, 271 and management information 272. The management server program, 271 communicates with the management client program 231. The management information 272 includes the past record information 140 and related information 281. The past record information 140 is information related to a past record such as the ending time of each of the steps for each product loaded in the production line. The past record information 140 may include the raw data mentioned above. The related information 281 is information related to the past record. A portion of the related information 281 may also be data generated on the basis of the result of analyzing the past record information 140.

Through a cooperative process performed by the management server program 271, the management client program 231, and the web browser 232, the display of a screen (typically GUI (Graphical User Interface)) including the diagram chart 170 is implemented

The relationships between the components shown in FIG. 2 and the components shown in FIG. 1 are, e.g, as follows. Specifically, of the I/F portions 211 and 251, at least the I/F portion 251 corresponds to the I/F portion 110. Of the storing portions 212 and 252, at least the storing portion 252 corresponds to the storing portion 120. Of the processor portions 213 and 253, at least the processor portion 253 corresponds to the processor portion 130. Of the management server program 271, the management client program 231, and the web browser 232, at least the management server program 271 corresponds to the support program 150.

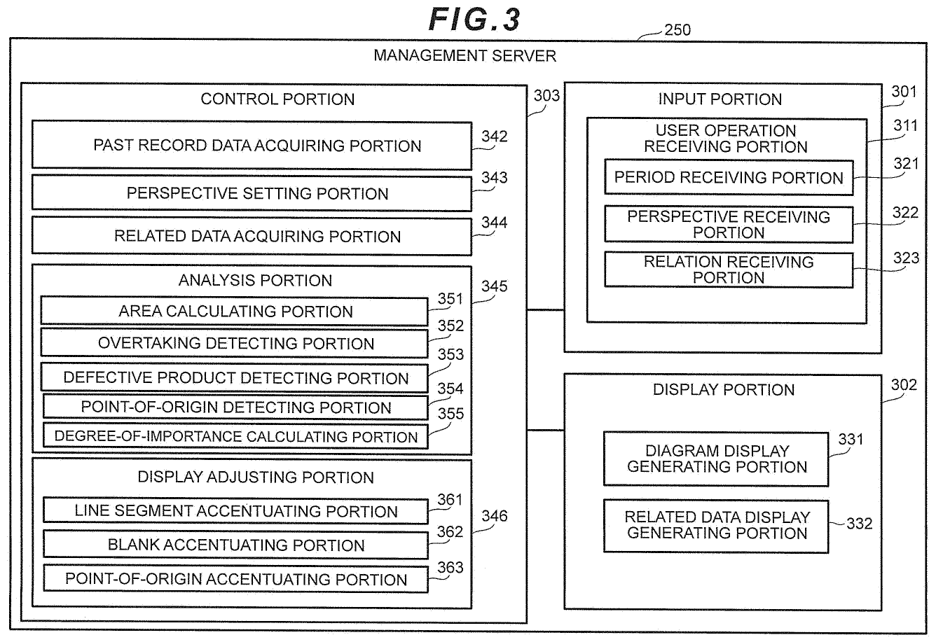

FIG. 3 shows an example of the functions implemented in the management server 250.

The management server program 271 is executed by the processor portion 253 to allow the illustrated functions, i.e., an input portion 301, a display portion 302, and a control portion 303 to be implemented. In other words, the management server program 271 has the input portion 301, the display portion 302, and the control portion 303.

The input portion 301 is the function for receiving information. The input portion 301 includes a user operation receiving portion 311. The user operation receiving portion 311 is a function for receiving a user operation (operation performed on the screen by the user using the input device). The user operation receiving portion 311 includes a period receiving portion 321, a perspective receiving portion 322, and a relation receiving portion 323. The period receiving portion 321 is a function for receiving a specification of the display target period. The perspective receiving portion 322 is a function for receiving a specification of the attentional perspective. The relation receiving portion 323 is a function for receiving a related data request.

The display portion 302 is the function for displaying information. The display portion 302 includes a diagram display generating portion 331 and a related data display generating portion 332. The diagram display generating portion 331 is a function for generating the display of the diagram chart. The related data display generating portion 332 is a function for generating the display of the related data.

The control portion 303 is the function for control. The control portion 303 includes a past record data acquiring portion. 342, a perspective setting portion 343, a related data acquiring portion 344, an analysis portion 345, and a display adjusting portion 346. The past record data acquiring portion 342 is a function for acquiring the past record data of a product. The perspective setting portion 343 is a function for setting the attentional perspective. The related data acquiring portion 344 is a function for acquiring the related data.

Note that the “past record data” is data showing the past record of production and including, e.g., a product ID (e.g., product number), a step ID (e.g., step number), a time (e.g., the collection time of the data or the ending time of the step), and a status (showing that, e.g. a process is currently performed in the step or the step was ended). For example, the past record data acquiring portion 342 regularly or irregularly collects the past record data from the line production system 200 and updates the past record information 140 on the basis of the collected past, record data.

On the other hand, the “related data” is data related to the past record of production (e.g., data other than the past record data, which is data of a predetermined type). For example, the related data acquiring portion 344 regularly or irregularly collects the related data from the line production system 200 and updates the related information 281 on the basis of the collected related data. The related data acquiring portion 344 also receives the related data (e.g., the related data input via a user interface screen such as the screen displayed by the web browser 232) from, e.g., the management client 210 and updates the related information 281 on the basis of the received related data. Note that, as an example of the related data, there is data related to facility trouble or a facility alert described later. The “facility trouble” is relatively serious trouble occurred in association with facilities. The “facility alert” is relatively negligible trouble occurred in association with the facilities. The “facility” is a machine provided for at least one of the steps, such as a product transfer robot.

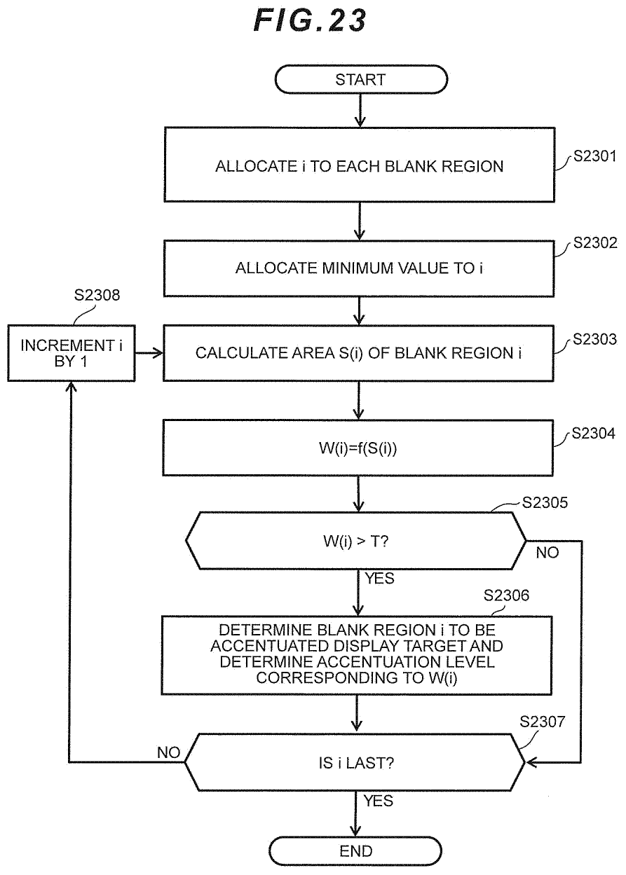

The analysis portion 345 is a function for analysis. The analysis portion 345 includes an area calculating portion 351, an overtaking detecting portion 352, a defective product detecting portion 353, a point-of-origin detecting portion 354, and a degree-of-importance calculating portion 355. The area calculating portion 351 is a function for calculating the area of the blank region. The overtaking detecting portion 352 is a function for detecting the occurrence of overtaking. The defective product detecting portion 353 is a function for detecting the occurrence of a defective product. The point-of-origin detecting portion 354 is a function for detecting the point of origin of the blank region. The degree-of-importance calculating portion 355 is a function for calculating the degree of importance (e.g., a weighting function f (x) described with reference to FIG. 23) of the blank region.

The display adjusting portion 346 is a function for adjusting display. The display adjusting portion 346 includes a line segment accentuating portion 361, a blank accentuating portion 362, and a point-of-origin accentuating portion 363. The line segment accentuating portion 361 is a function for generating the accentuated display of a line segment. The blank accentuating portion 362 is a function for generating the accentuated display of the blank region. The point-of-origin accentuating portion 363 is a function for generating the accentuated display of the point of origin of the blank region.

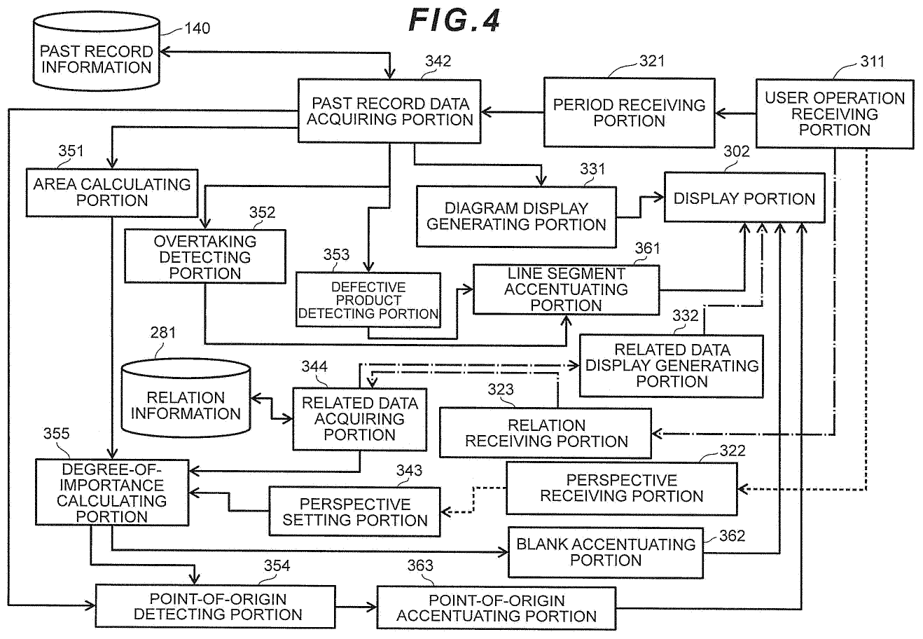

FIG. 4 shows a representative example of the relations among the functions shown in FIG. 3.

The user operation receiving portion 311 receives a user operation.

When the user operation received by the user operation receiving portion 311 is a specification of the display target period, e.g., the function is implemented in accordance with the flow shown by the solid line. Specifically, the period receiving portion 321 receives the display target period from the user operation receiving portion 311. The past record data acquiring portion 342 receives the display target period from the period receiving portion 321 and acquires the past record data corresponding to the display target period from the past record information 140. On the basis of the acquired past record data, at least one of groups of the functions (including one or more functions) shown below is implemented, which are:
the group of the functions 351, 355, and 362 (as necessary, at least one of the functions 344 and 363) ;
the group of the functions 352 and 361;
the group of the functions 353 and. 361; and
the group of the functions 354 and 363.

On the basis of the result of implementing the group of the functions, the display portion 302 is implemented, with the result that information including the diagram chart is displayed. The group of the functions to be implemented may also be determined on the basis of the adopted attentional perspective. The point-of-origin detecting portion 354 (detection of the point of origin of the blank region) may also be implemented on the basis of the degree of importance (degree of importance of the blank region) calculated by the degree-of-importance calculating portion 355 (e.g., may also be implemented for the blank region when the degree of importance is equal to larger than a predetermined value).

When the user operation received by the user operation receiving portion 311 is a specification of a related item, the function is implemented in accordance with, e.g., the flow shown by the dot-dash line. Specifically, the relation receiving portion 323 receives the specified related item from the user operation receiving portion 311. The related data acquiring portion 344 receives the related item from the relation receiving portion 323 and acquires the related data corresponding to the related item from the related information 281. The related data display generating portion 332 receives the acquired related data from the related data acquiring portion 344, and the display portion 302 displays the related data.

When the user operation received by the user operation receiving portion 311 is a specification of the attentional perspective, the function is implemented in accordance with the flow shown by, e.g., the broken line. Specifically, the perspective receiving portion 322 receives the specified attentional perspective from the user operation receiving portion 311. The perspective setting portion 343 receives the attentional perspective from the perspective receiving portion 322 and sets the attentional perspective (e.g., the attentional perspective may also be included in the related information 281). The perspective setting portion 343 can give the attentional perspective to the degree-of-importance calculating portion 355. The degree-of-importance calculating portion 355 can calculate the degree of importance of the blank region on the basis of at least one of the set attentional perspective, the degree of importance of the attentional perspective, and the related data of the blank region.

The relations among the functions are not limited to the example shown in FIG. 4. For example, it may also be possible to select the group of the functions to be implemented using the past record data acquired by the past record data acquiring portion 342 on the basis of the attentional perspective received by the perspective setting portion 343. For example, when the attentional perspective “OCCURRENCE OF OVERTAKING” is not set (specified), the overtaking detecting portion 352 is implemented but, when the attentional perspective “OCCURRENCE OF DEFECTIVE PRODUCT” is not set, the defective product detecting portion 353 need not be implemented.

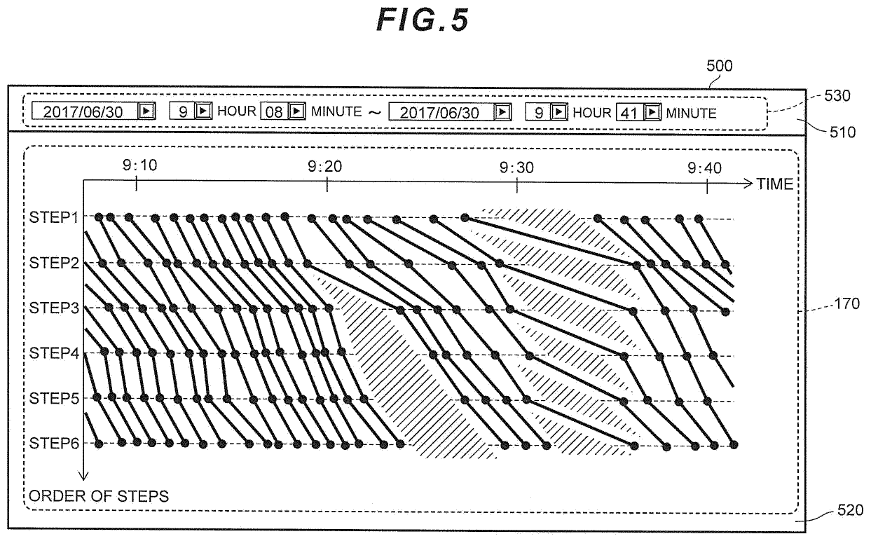

FIG. 5 shows an example of a diagram chart screen.

A diagram chart screen 500 is, e.g., a GUI (Graphical User Interface) and has a UT (user interface) area 510 and a graph area 520.

On the UI area 510, a period specification UI 530 is displayed. The period specification UI 530 is the UT (e.g., GUI component) that receives a specification of the display target period. The “display target period” is the period of the production situation determined to be a display target among the managed production situations. In the present embodiment, as shown in the drawing, the display target period is specified by a pair of a starting time and an ending time. However, the display target period may also be specified by another method, e.g., a pair of a reference time (e.g., starting time) and a length or by scrolling a display range (scrolling along the direction of the axis corresponding to time).

On the graph area 520, the diagram chart 170 showing the production situation during the display target period specified using the period specification UI 530 is displayed. The chart 170 is a two-dimensional graph in which an abscissa axis (an example of a first axis) corresponds to time, an ordinate axis (an example of a second axis orthogonal to the first axis) corresponds to the steps, and one polygonal line corresponds to one product. For each product, a point for each step (point on the polygonal line) corresponds to the ending time of the step.

Along the ordinate axis, steps are arranged in the order in which the steps are present in the production line. For each of the products belonging to the display target period, respective points corresponding to the respective ending times of a plurality of steps through which the product passed are plotted. By connecting the points with a line, the polygonal line is formed, the result of which is displayed as the diagram chart 170.

On the diagram chart 170 shown in FIG. 5, at the time at which the diagram chart 170 is displayed, the blank regions are al ready subjected to the accentuated display as an example of the noteworthy display objects. However, whether or not the display objects are to be subjected to the accentuated display (to be automatically recommended) may also be settable by a user operation.

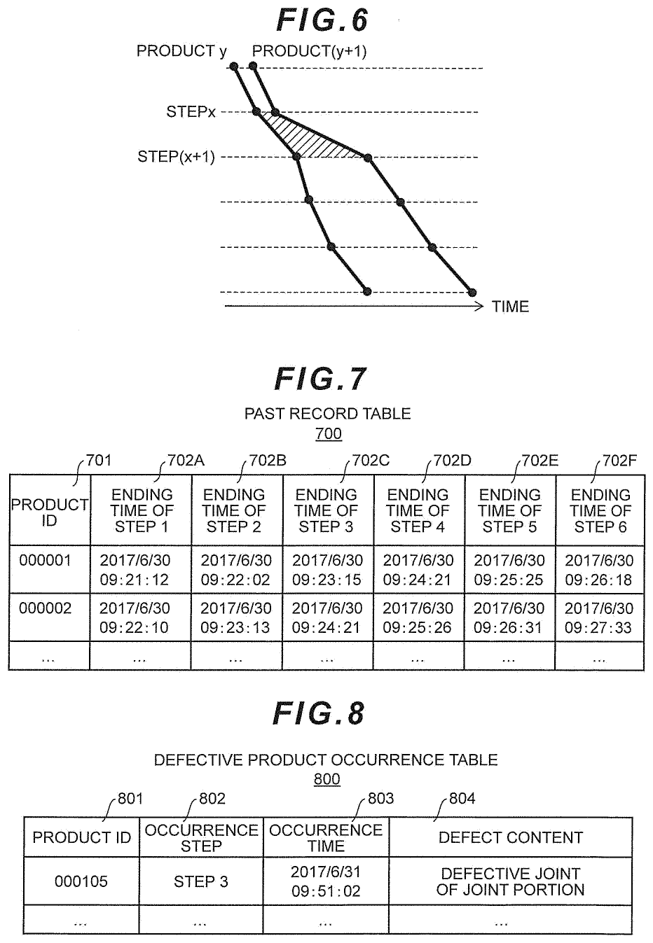

FIG. 6 is a schematic diagram showing the definition of the blank region.

It is assumed that steps which are adjacent in the order thereof are a step x (x-th step) and a step (x+1) (where x is a natural number). It is also assumed that products which are adjacent in the order thereof in terms of the ending times of the step x are a product y (y-th product loaded in the production line) and a product (y+1) (y is a natural number). On such assumptions, a blank region is a region bounded by four points (coordinates) shown below which are:
the point corresponding to the step a and the ending time of the step x for the product y;
the point corresponding to the step (x+1) and the ending time of the step (x+1) for the product y;
the point corresponding to the step x and the ending time of the step x for the product (y+1); and
the point corresponding to the step (x+1) and the ending time of the step (x+1) for the product (y+1).

Note that a “line segment” for the product y is a line connecting two points for adjacent two steps, i.e., a line connecting the point corresponding to the ending time of the step x and the point corresponding to the ending time of the step (x+1).

A specific example of the past record information 140 and the related information 281 each described above will be described. Note that, in the present embodiment, for the sake of convenience, information included in the management information 272 as the information managed in the management server 250 and other than the past record information 140 is assumed to the related information 281. The table shown in FIG. 7 is the table included in the past record information 140, which shows an example of input data used to produce the diagram chart. The tables shown in FIGS. 8 to 11 are the tables included in the related information 281, which show examples of the input data used when the blank regions on the diagram chart 170 are analyzed.

FIG. 7 shows a past record table.

A past record table 700 is prepared for, e.g., each production line. The past record table 700 holds information related to the past record of production. Specifically, the past record table 700 shows a history of products flowing in the production line and the ending times of the steps included in the production line. More specifically, the past record table 700 has, e.g., records for individual products on a one-to-one basis. Each of the records stores information such as a product ID 701 and ending times 702A to 702F of steps 1 to 6 included in the production line.

In the present embodiment, the ending time of each of the steps is an example of the execution time of the step. The execution time may appropriately be one or more times between the starting time of the step and the ending time thereof.

Also, in the present embodiment, a time is represented in a year/month/day/hour/minute/second unit, but the unit of a time may be rougher or finer than the unit used in the present embodiment. A time may also be represented in a different unit.

FIG. 8 shows a defective product occurrence table.

A defective product occurrence table 800 is prepared for, e.g., each production line. The defective product occurrence table 800 holds information related to defective products (abnormal products) occurred in the production line. Specifically, for example, the defective product occurrence table 800 has records for individual defective products on a one-to-one basis. Each of the records stores information such as a product ID 801, an occurrence step 802, an occurrence time 803, and a defect content 804.

The product ID 801 shows the ID of a product as a defective product. The occurrence step 802 shows the step (e.g. step ID) in which a defect (abnormality) has occurred. The occurrence time 803 shows the time at which the defect has occurred. The defect content 804 shows the details of the defect.

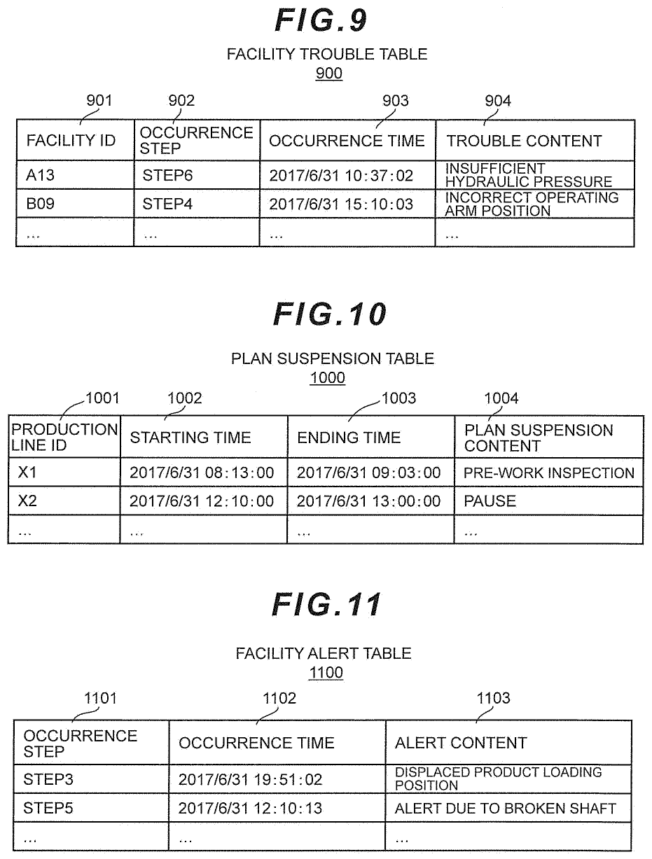

FIG. 9 shows a facility trouble table.

A facility trouble table 900 is prepared for, e.g., each production line. The facility trouble table 900 holds information related to production trouble associated with the production line. Specifically, for example, the facility trouble table 900 has records for individual facilities on a one-to-one basis. Each of the records stores information such as a facility ID 901, an occurrence step 902, an occurrence time 903, and a trouble content 904.

The facility ID 901 shows the ID of the facility in which trouble has occurred. The occurrence step 902 shows the step in which the trouble has occurred. The occurrence time 903 shows the time at which the trouble has occurred. The trouble content 904 shows the details of the trouble.

FIG. 10 shows a plan suspension table.

A plan suspension table 1000 holds information related to plan suspension performed in production lines. Specifically, for example, the plan suspension table 1000 has records for the individual production lines on a one-to-one basis. Each of the records stores information such as a production line ID 1001, a starting time 1002, an ending time 1003, and a plan content 1004.

The production line ID 1001 shows the ID of the production lane in which plan suspension was performed. The starting time 1002 shows the starting time of the plan suspension. The ending time 1003 shows the ending time of the plan suspension. The plan content 1004 shows the details of the plan suspension.

FIG. 11 shows a facility alert table.

A facility alert table 1100 is prepared for, e.g., each production line. The facility alert table 1100 holds information related to the facility alerts output from production associated with the production line. Specifically, for example, the facility alert table 1100 has records for individual facility alerts on a one-to-one basis. Each of the records stores information such as an occurrence step 1101, an occurrence time 1102, and an alert content 1103.

The occurrence step 1101 shows the step in which a facility alert is output. The occurrence time 1102 shows the time at which the facility alert is output. The alert content 1103 shows the details of the facility alert. Note that the “facility alert” is data including the details of the alert and output from a monitoring apparatus for facilities when an alert results from the detection of trouble associated with the facilities by the monitoring apparatus or the like.

Display control is performed on the basis of the tables 700, 800, 900, 1000, and 1100 described above. In the display control, accentuated display generated, specifically data on the attribute (e.g., color) of the accentuated display is generated, and the accentuated splay in accordance with the data is performed. The display object determined to be the accentuated display target is typically the polygonal line or the blank region.

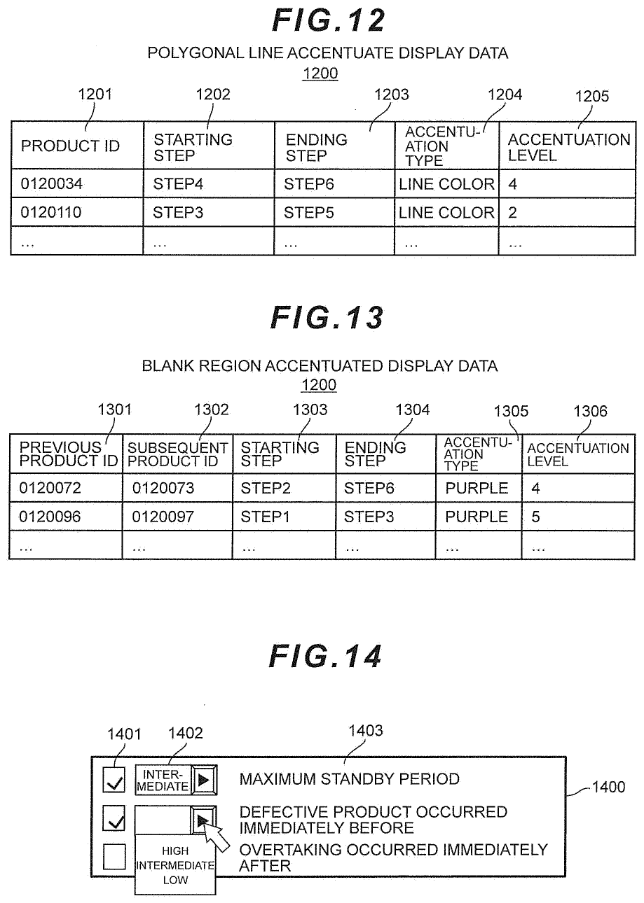

FIG. 12 shows an example of polygonal line accentuated display data.

Polygonal line accentuated display data 1200 has records for individual polygonal lines as the accentuated display targets on a one-to-one basis o Each of the records stores information such as a product. ID 1201, a starting step 1202, an ending step 1203, an accentuation type 1204, and an accentuation level 1205.

The product ID 1201 shows the ID of the product corresponding to the polygonal line. The starting step 1202 shows the first one of the steps corresponding to the line segment as the accentuated display target. The ending step 1203 shows the last one of the steps corresponding to the line segment as the accentuated display target. The accentuation type 1204 shows the display mode (such as e.g., a color or line type) of the polygonal line. The accentuation level 1205 shows a numerical value as an accentuation level (level of the accentuated display). As the numerical value is larger, the accentuation level is higher, and therefore the degree of accentuation is higher.

FIG. 13 shows an example of blank region accentuated display data.

A blank region accentuated display data 1300 has records for individual sets of consecutive blank regions on a one-to-one basis. The “consecutive blank regions” are one or more blank regions among the plurality of blank regions each sandwiched between two polygonal lines which are determined to be the accentuated display targets and are consecutive in a vertical direction (direction along the ordinate axis). Each of the records stores information such as a previous product ID 1301, a subsequent product ID 1302, a starting step 1303, an ending step 1304, an accentuation type 1305, and an accentuation level 1306.

The previous product ID 1301 shows the ID of a previous product (product y), i.e., product corresponding to the anterior one of the two polygonal lines between which the consecutive blank regions are sandwiched. The subsequent product ID 1302 shows the ID of a subsequent product (product (y+1)), i.e., product corresponding to the posterior one of the two polygonal lines between which the consecutive blank regions are sandwiched. The starting step 1303 shows the first one of the steps corresponding to the consecutive blank regions. The ending step 1304 shows the last one of the steps corresponding to the consecutive blank regions. The information items 1301 to 1304 define the consecutive blank regions. The accentuation type 1305 shows the display mode (e.g., color) of the blank region. The accentuation level 1306 shows a numerical value as an accentuation level (level of the accentuated display).

In the present embodiment, as described above, the display object satisfying the requirement associated with the attentional perspective is subjected to the accentuated display. It may also be possible to allow a user to specify which one of the polygonal line and the blank region is used as the type of the display object determined to be the accentuated display target. It may also be possible that at least one of the attentional perspectives is associated with the degree of importance of the attentional perspective.

FIG. 14 shows an example an attentional perspective specification UI.

An attentional perspective specification UI 1400 has, for each attentional perspective that can be specified by the user, a selection UI 1401, a degree of importance specification UI 1402, and an attentional perspective character string 1403.

The selection UI 1401 is a UI (e.g., check box) which receives whether or not an attentional perspective is selected as the attentional perspective to be specified. The degree-of-importance specification UI 1402 is a UI which receives a degree of importance (e.g., any of high, intermediate, and low three levels) to be associated with the attentional perspective. The attentional perspective character string 1403 is a character string showing the content of the attentional perspective.

The reception of the specification of the attentional perspective (and the degree of importance thereof) via the attentional perspective specification UI 1400 and the setting of the specified attentional perspective (and the degree of importance thereof) is performed by the management server program 271 (i.e., in FIG. 4, the perspective receiving portion 322 and the perspective setting portion 343 are implemented).

As the attentional perspective, various perspectives can be adopted. For example, as the attentional perspective that can be specified, at least one of perspectives shown below can be adopted, which are:
the size of an interval (e.g., a work suspension period in the same step (the difference between the ending time of the product y and the ending time of the product (y+1)));
the area of a blank region;
a target step;
the type of a facility (machine) associated with a production line;
the type of target work;
the occurrence of overtaking;
the relationship with the occurrence of overtaking (e.g., whether or not overtaking has occurred immediately before (a given time before) or immediately after (a given time after)
the occurrence of a defective product;
the relationship with the occurrence of a defective product (e.g., whether or not a defective product has occurred immediately before or immediately after);
the type of the occurred defect;
the degree of overtaking (e.g., the number of the overtaken products);
the magnitude of a specific measurement value;
the changing tendency of a specific measurement value;
the type or content of a facility alert;
a worker;
the type or content of data in a work record file (records of events (e.g., alert or work) occurred in a production site) associated with the occurrence time of at least, one of a defective product, facility trouble, and a facility alert;
elimination of a display object associated with plan suspension from the accentuated display targets;
a maximum standby period; and
the point of origin of a blank region.
   There may be at least one of an attentional perspective for which it is fixedly set in advance that selection of whether or not the attentional perspective is specified by a user is impossible and an attentional perspective for which selection of whether or not the attentional perspective is specified by a user is possible.

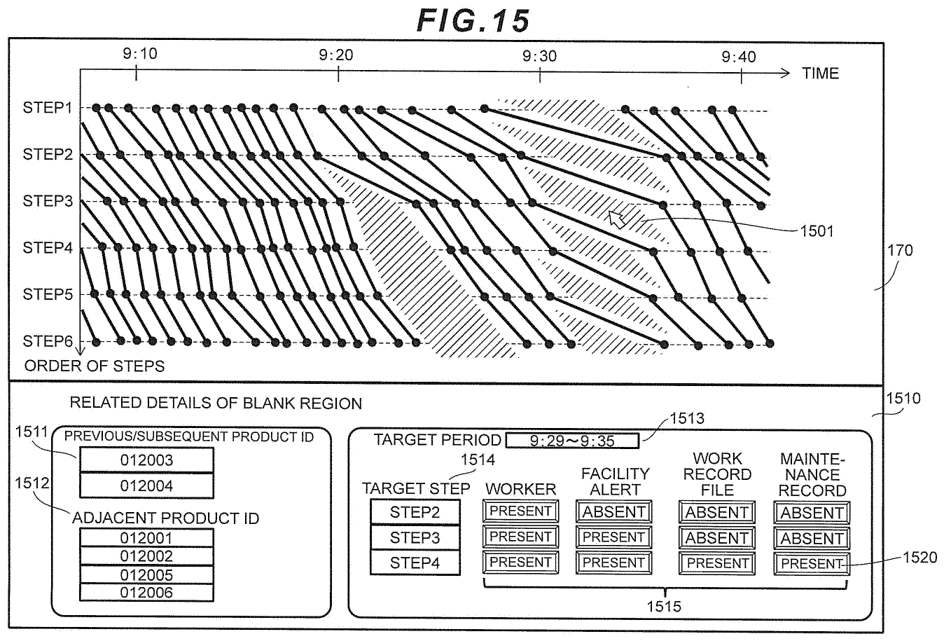

In the present embodiment, the management server program 271 analyzes the past record information 140 (past record table 700) on the basis of the set (specified) attentional perspective and performs accentuated display of the display object determined on the basis of the result of the analysis. The management server program 271 also receives a request for the related data (e.g., request to display the related data corresponding to the display object intended by the user) via the diagram chart screen or another screen, acquires the requested related data from the related information 281, and displays the acquired related data (i.e., in FIG. 4, the functions 323, 344, and 332 are implemented). Referring to FIGS. 15 to 17, the following will describe an example of the acquisition and display of the related data.

As shown in FIG. 15, it is assumed that, on the diagram chart 170, some of the blank regions are subjected to accentuated display. When receiving a specification of a given blank region 1501 subjected to the accentuated display (e.g., superimposition of a mouse cursor on the blank region 1501 or double clicking on the blank region 1501) from the user, the management server program 271 uses, as a key, at least one of the vertices (e.g., the information items 1301 to 1304 showing the four vertices defining the consecutive blank regions) of at least the blank region 1501 of the consecutive blank regions including the blank region 1501 to acquire the related data corresponding to at least the blank region 1501 of the consecutive blank regions from the related information 281. In other words, the acquired related data may be data related only to the specified blank region 1501 or data related to each of the blank regions included in the consecutive blank regions including the blank region 1501. The management server program 271 displays, as related details 1510, information including at least a portion of the acquired related data on the screen including the diagram chart 170 or on another screen.

The related details 1510 include, e.g., a previous/subsequent product ID 1511, an adjacent product ID 1512, a target time 1513, a target step 1514, and step details 1515.

The previous/subsequent product ID 1511 is a list of the product IDs of the previous product y and the subsequent product (y+1) which respectively correspond to the two lines between which the blank region 1501 is sandwiched. The adjacent product ID 1512 is a list of the product IDs of p products (y−j) which are closer to the previous product among the products loaded earlier than the previous product y and the product IDs of q products (y+1+k) which are closer to the subsequent product among the products loaded later than the subsequent product (y+1). Note that j=1, 2, . . . and p is a natural number. Also, k=1, 2, . . . and g is a natural number.

The target time 1513 shows the first time and the last time among the times belonging to the blank region 1501.

The target step 1514 is a list of the steps belonging to the blank region 1501. The step details 1515 include buttons (which may also be a UI of another type) showing, for each of the steps shown by the target step 1514, the presence or absence of information with regard to each of the plurality of types of attribute items (e.g., worker, facility alert, work record file, and maintenance record). In the buttons, the presence or absence of the information is represented by characters but, instead or in addition thereto, another expression (e.g., different colors) may also be used to represent the presence or absence of the information.

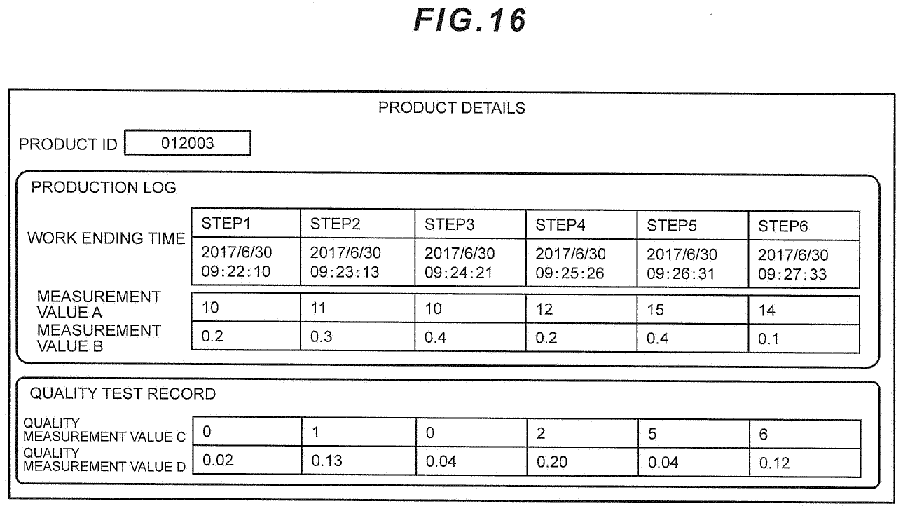

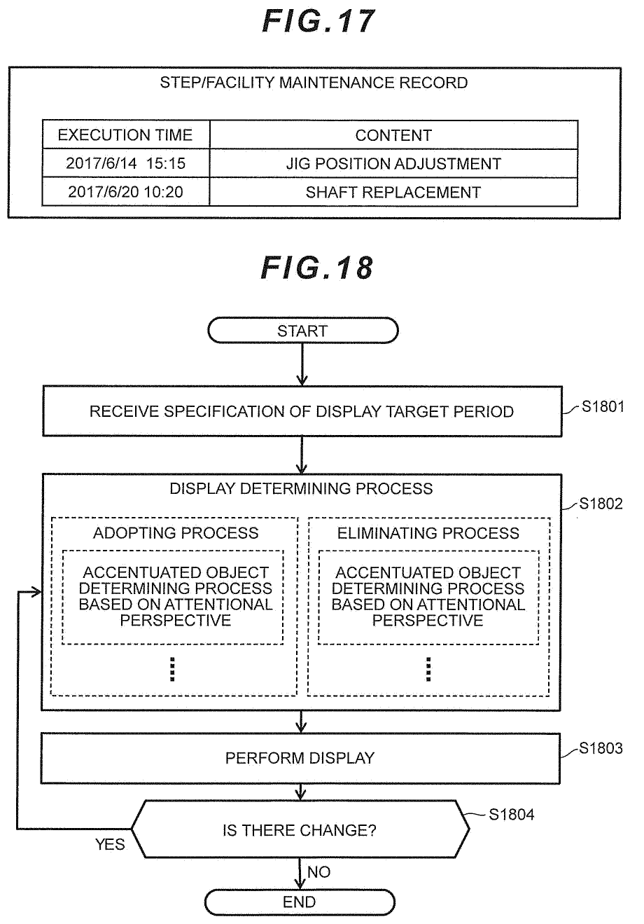

The management server program 271 receives a user operation for displaying the details of a predetermined type of information in the related details 1510. For example, when receiving a request to display the details of the product ID “012003” in the previous/subsequent product ID 1511, the management server program 271 displays product details for the product ID “012003” in the related information 281 (see FIG. 16). Also, for example, when a button 1520 (button corresponding to step 4 and the maintenance record) in the step details 1515 is pushed, the management server program 271 displays the maintenance record related to step 4 in the related information 281 (see FIG. 17).

Note that the related data may also be acquired from an external system such as the line production system 200. For example, the management server program 271 transmits, to the external system, a related data acquisition request including information belonging to a display object such as the blank region 1501 (e.g., the ending times of the steps belonging to the blank region 1501, the IDs of the steps, the previous product ID, and the subsequent product ID). In response to the request, the management server program 271 receives, from the external system, the related data (e.g., data on the occurrence of a defective product corresponding to the product ID and facility trouble or a facility alert in facilities in the vicinity of the ending time of a step or in the step) specified from the information included in the request.

The following will describe an example of the processes performed in the present embodiment.

FIG. 18 shows the flow of a display control process.

When receiving a specification of the display target period via the period specification UI 530 (S1801), the management server program 271 performs a display determining process (S1802) The display determining process includes one or more accentuated object determining processes respectively corresponding to the set one or more attentional perspectives. In the display determining process (S1802), generation of such accentuated display data as shown by way of example in FIGS. 12 and 13 is performed (generation of accentuated display in FIGS. 3 and. 4 is performed) and, on the basis of the data, the management server program 271 displays a diagram chart (S1803).

When an operation of changing the specified attentional perspective (or the degree of importance thereof) is performed (Yes in S1804), the management server program 271 performs S1802 on the basis of the changed attentional perspective (or the degree of importance thereof).

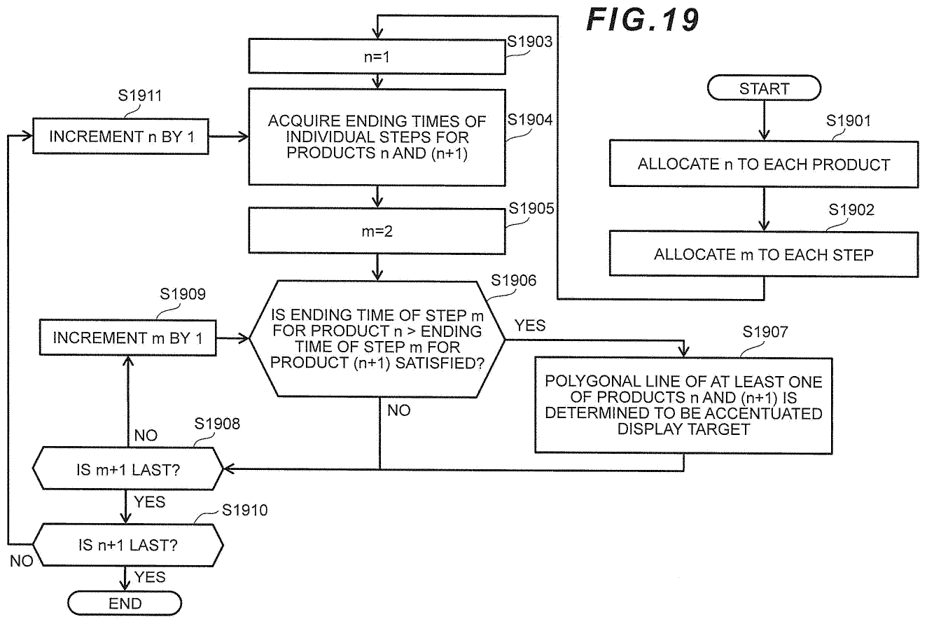

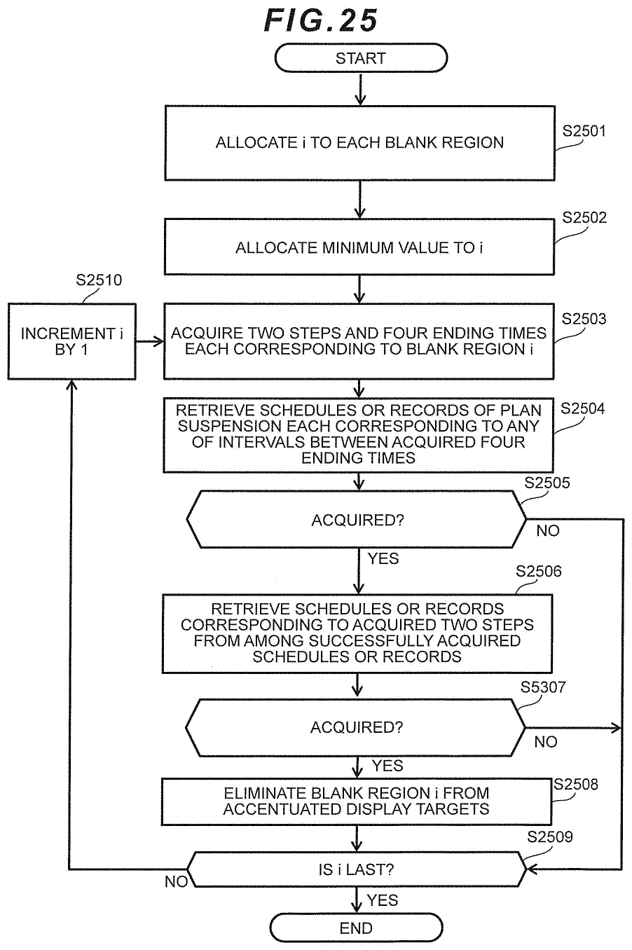

The “accentuated object determining process” is a process of determining a display object to be adopted as the accentuated display target or determining: a display object to be eliminated from the accentuated display targets. In other words, each of the one or more accentuated object determining processes included in the display determining process is either the adopting process or the eliminating process. The display determining process includes at least the adopting process. The adopting process is the process of determining the display object to be adopted as the accentuated display target. The eliminating process is the process of determining the display object to be eliminated from the accentuated display targets. A combination of the result of the adopting process and the result of the eliminating process results in a final result (determination) and, in accordance with the final result, display (51803) is performed. Examples of the adopting process are shown in. FIGS. 19, 21, 23, 26, 27, 28, and 30. An example of the eliminating process is shown in FIG. 25. Specifically, the chart display determining process (S1802) includes the process shown by at least one of FIGS. 19, 21, 23, 26, 27, 28, and 30 and can further include the process shown by FIG. 25. In the chart display determining process, the type of the display object determined to be the accentuated display target depends on the adopted (specified) attentional perspective. For example, when the attentional perspective is related directly to a product, such as at least one of “OCCURRENCE OF OVERTAKING” and “OCCURRENCE OF DEFECTIVE PRODUCT” (when related to tree very product), the display object adopted as the accentuated display target is the polygonal line (a line segment as at least a portion of the polygonal line). For example, when the attentional perspective is related indirectly to a product, such as at least one of “AREA. OF BLANK REGION”, “MAGNITUDE OF SPECIFIC MEASUREMENT”, “WORKER”, and “RELATIONSHIP WITH OCCURRENCE OF DEFECTIVE PRODUCT”, the display object adopted as the accentuated display target is the blank region. For example, when the display object adopted as the accentuated display target is the blank region, a point serving as the point of origin (plotted point) of the blank region can also be adopted as one of the display objects determined to be the accentuated display targets.

The following will describe some specific examples of the accentuated object determining processes. In the following specific examples, the determination of the accentuated display target and the determination of the accentuation level corresponds to the generation of the accentuated display in FIGS. 3 and 4 (generation of such accentuated display data as shown by way of example in FIGS. 12 and 13).

<Specific Examples of Case Where Display Object as Accentuated Display Target is Polygonal Line>

FIG. 19 shows the flow of the accentuated object determining process corresponding to the attentional perspective “OCCURRENCE OF OVERTAKING”.

The management server program 271 refers to the past record table 700 and allocates, to each of all the products present in a production line during the display target period, an index number n showing the ordinal number of the ending time of a first step (S1901). As the ending time is earlier, the index number n (ordinal number) is smaller. Note that n is a serial number.

The management server program 271 also allocates, to each of ail the steps in the production line, an index number m showing the ordinal number of the step (n.902). As the step is earlier, the index number m is smaller. Note that m is a serial number

The management server program 271 allocates 1 to n (S1903).

The management server program 271 acquires, from the past record table 700, the ending times of the individual steps for a product n (product having the index number n) and a product (n+1) (S1904).

The management server program 271 allocates 2 to m (S1905). Note that m=2 means a step subsequent to the first step.

The management server program 271 determines whether or not overtaking has occurred in a step m (step having the index number m.), i.e., whether or not the ending time for the product n is later than the ending time for the product (n+1) in step m (S1906).

When the result of the determination in S1906 is true (Yes in S1906), the management server program, 271 determines that at least one of the polygonal line corresponding to the product n and the polygonal line corresponding to the product (n+1) is the accentuated display target (S1907). In S1907, instead of determining that the whole polygonal line is the accentuated display target, the management server program 271 may also determine that the line segment between the steps m and (m+1) of at least one of the polygonal line corresponding to the product n and the polygonal line corresponding to the product (n+1) is the accentuated display target. In S1907, the management server program 271 may also specify, for the step m, all the products that were loaded later than the product n (have index numbers larger than that of the product n) but have ending times earlier than that of the product n on the basis of the past record table 700 and determine that the polygonal lines of all the specified products including the product (n+1) are the accentuated display targets.

When the result of the determination in S1906 is false (No in S1906) or after S1907, the management server program 271 determines whether or not (m+1) is the last one (maximum value) of the index numbers of the steps (S1908). When the result of the determination in S1908 is false (No in S1908), the management server program 271 increments m by 1 (S1909) and performs S1906.

When the result of the determination in S1908 is true (Yes in S1908), the management server program 271 determines whether or not (n+1) is the last one (maximum value) of the index numbers of the products (S1910). When the result of the determination in S1910 is false (No in S1910), the management server program 271 increments n by 1 (S1911) and performs S1904. When the result of the determination in S1910 is true (Yes in S1910), the process is ended.

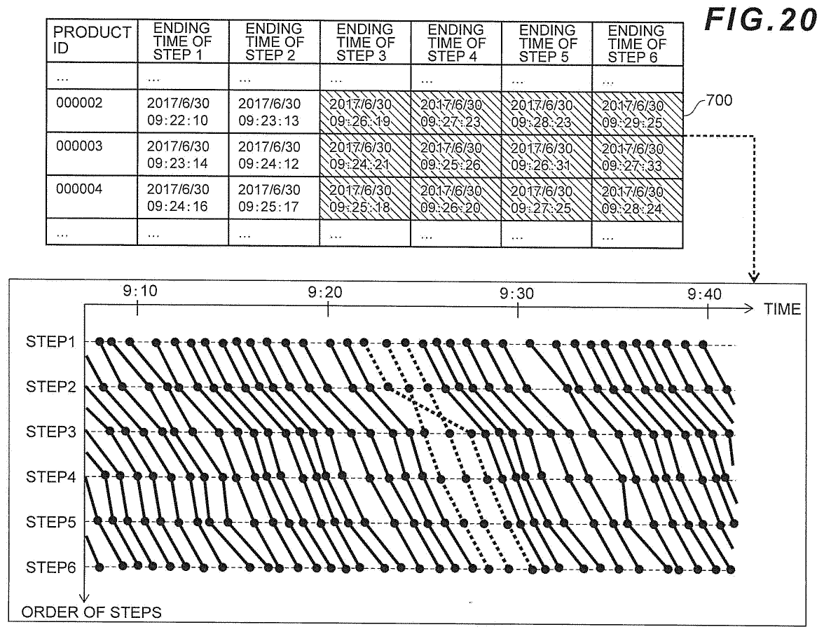

FIG. 20 shows an example of the past record table 700 showing overtaking and an example of the accentuated display based on the result of the process in FIG. 19.

In the process in FIG. 19, when the past record table 700 shown by way of example in FIG. 20 is referenced, in accordance with the cells in the past record table 700 corresponding to the product IDs “000002” to “000004” and steps 3 to 6, the polygonal lines corresponding to the products having the product IDs “000002” to “000004” are subjected to accentuated display (e.g., in bold lines or broken lines).

This allows a user to promptly specify the overtaken product and the step and the time in and at which overtaking has occurred.

Note that the management server program 271 may also determine that the blank region is the display object adopted as the accentuated display target. For example, the management server program 271 may also perform accentuated display of all the blank regions between the polygonal line corresponding to the product immediately previous to the product n and the polygonal line corresponding to the product subsequent to the last one of the products that have overtaken the product n (or only the blank region to which the step in which overtaking has occurred belongs).

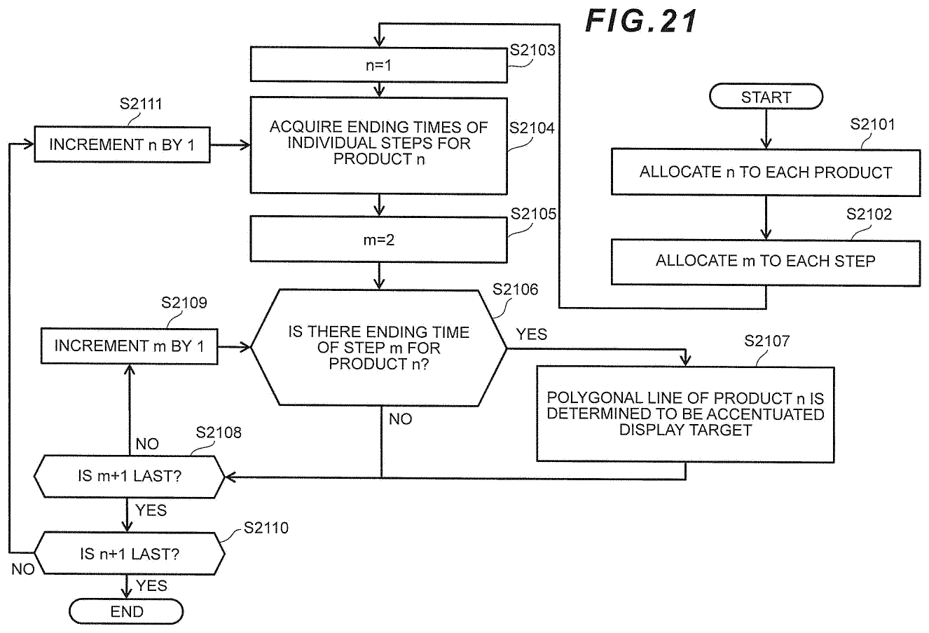

FIG. 21 shows the flow of the accentuated object determining process corresponding to the attentional perspective “OCCURRENCE OF DEFECTIVE PRODUCT”.

The management server program 271 performs the same process as in S1901 to S1903 (S2101 to S2103). Note that, when both of the processes in FIGS. 19 and 21 are performed, S1901 to S1903 may also be shared. In other words, a process shared between a plurality of processes need not repeatedly be performed.

The management server program 271 acquires, from the past record table 700, the ending times of the individual steps for the product n (S2104).

The management server program 271 allocates 2 to m (S2105).

The management server program 271 determines whether or not there is the ending time of the product n for the step m (S2106).

When the result of the determination in S2106 is false (No in S2106), the result means that the product has been retrieved from the production line in a middle step. Accordingly, the management server program 271 determines that the polygonal line corresponding to the product n is the accentuated display target (S2107).

When the result of the determination in S2106 is true (Yes in S2106) or after S2107, the management server program 271 performs the same process as in S1908 to S1911 (S2108 to S2111).

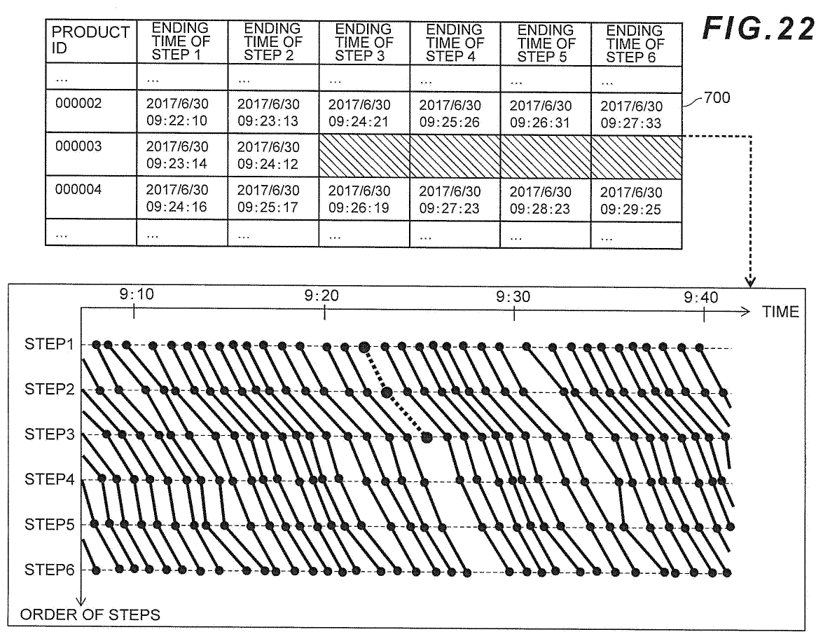

FIG. 22 shows examples of the past record table 700 showing the occurrence of a defective product and an example of the accentuated display based on the result of the process in FIG. 21.

In the process in FIG. 21, when the past record table 700 shown by way of example in FIG. 22 is referenced, in the past record table 700, the cells corresponding to the product ID “000003” and steps 3 to 6 have no ending time so that the polygonal line corresponding to the product having the product ID “000003” is subjected to the accentuated display (e.g., in a bold line or broken line) The mode of the accentuated display may be either the same as or different from that for the occurrence of overtaking.

This allows the user to promptly specify the occurred defective product and the step and the time in and at which the defective product has occurred.

<Specific Example of Case Where Display Object as Accentuated Display Target is Blank Region>

FIG. 23 shows the flow of the accentuated object determining process corresponding to the attentional perspective “AREA OF BLANK REGION”.

The management server program 271 allocates an index number i to each of all the blank regions (blank regions specified on the basis of the past record table 700) present in the diagram chart during the display target period (S2301). Note that i is a serial number.

The management server program 271 allocates the minimum value of the index numbers to i (S2302).

The management server program 271 calculates an area S(i) of the blank region i (blank region having the index number i) (S2303). As a method of calculating the area, any method may be adopted.

The management server program 271 calculates W(i) resulting from the application of the weighting function f (x) to the area S(i) (S2304). As a result, the area S (i) is changed in accordance with the weight of the blank region i. The weighting function f (x) of the blank region i may also be based on at least one of items shown below which are:
the degree of importance of the attentional perspective “AREA OF BLANK REGION” (e.g., a relative difference from the degree of importance of another attentional perspective)
related data (e.g., a measurement value) corresponding to the blank region i;
the number of the other attentional perspectives on the basis of which the blank region is determined to be the accentuated display target; and
the degrees of importance of the other attentional perspectives on the basis of which the blank region i is determined to be the accentuated display target.
   It may also be possible to satisfy W(i)=S(i) without adopting the weighting function f (x).

The management server program 271 determines whether or not W(i) is larger than a threshold I (S2305). The threshold T may be a fixed value or a variable value (e.g., value determined by the management server program 271 on the basis of the tendency (statistics) of the areas of the blank regions on the diagram chart).

When the result of the determination in S2305 is true (Yes in S2305), the management server program 271 determines that the blank region i is the accentuated display target and also determines the accentuation level (e.g., color shade) based on the magnitude of W(i) (S2306).

The management server program 271 determines whether or not i is the last one (maximum value) of the index numbers (S2307). When the result of the determination in S2307 is false (No in S2307) the management server program 271 increments i by 1 (S2308) and performs S2303.

When the result of the determination in S2307 is true (Yes in S2307), the process is ended.

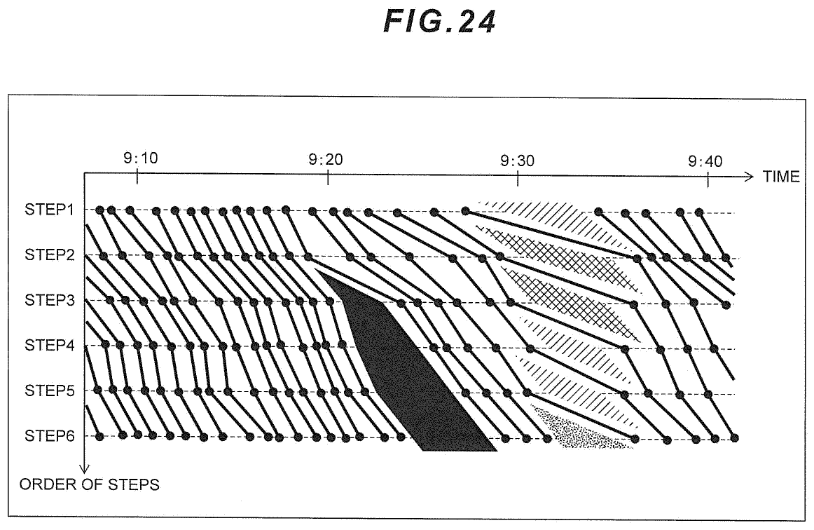

FIG. 24 shows an example of the accentuated display based on the result of the process in FIG. 23.

According to FIG. 23, the blank region as the accentuated display target is subjected to the accentuated display in a mode in accordance with the magnitude of W(i) (the magnitude of the area of the blank region i and the weight related to the blank region i).

FIG. 25 shows the flow of the accentuated object determining process (eliminating process) corresponding to the attentional perspective “ELIMINATION OF DISPLAY OBJECT ASSOCIATED WITH PLAN SUSPENSION FROM ACCENTUATED DISPLAY TARGETS”.

The management server program 271 performs the same process as in S2301 and S2302 (S2501 and S2502). Note that, when both of the processes in FIGS. 23 and 25 are performed, S2301 and S2302 may also be shared. In other words, a process shared between a plurality of processes need not repeatedly be performed. This similarly applies to any two or more of the processes in FIGS. 23 and 25 to 28.

The management server program 271 acquires, from the past record table 700, two steps and four ending times each corresponding to the blank region i (S2503).

The management server program 271 retrieves, from the related information 281, the schedules or records of plan suspension corresponding to any of the intervals between the acquired four ending times (S2504).

When the schedules or records are found (Yes in S2505) the management server program 271 i retrieves, from the successfully acquired schedules or records, the schedules or records corresponding to the acquired two steps (S2506).

When the schedules or records are found (Yes in S2507), the management server program 271 determines to eliminate the blank region i from the accentuated display targets (S2508).

The management server program 271 determines whether or not i is the last one (maximum value) of the index numbers (S2509). When the result of the determination in S2509 is false (No in S2509), the management server program 271 increments i by 1 (S2510) and performs S2503.

When the result of the determination in S2509 is true (Yes in S2509), the process is ended.

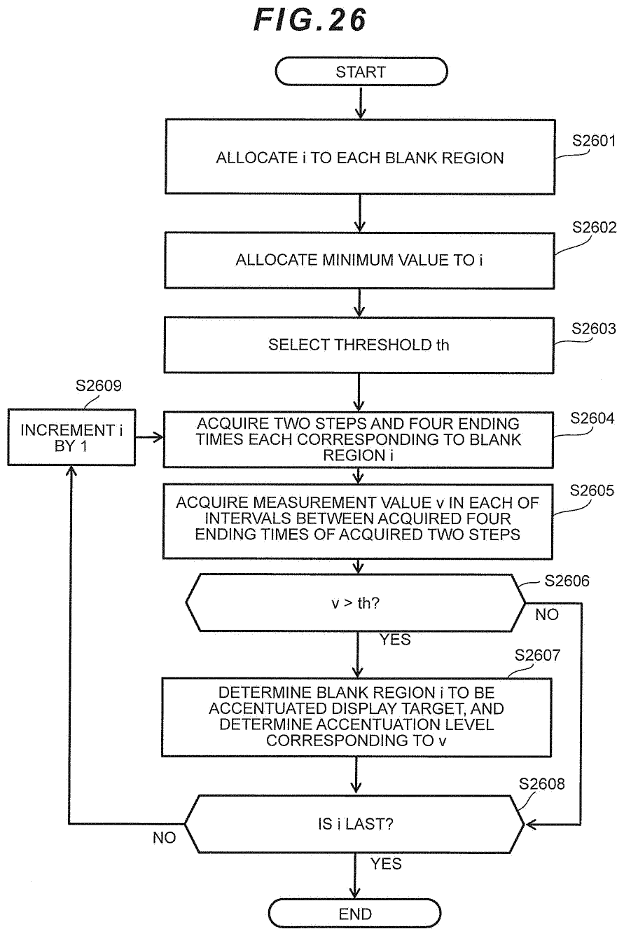

FIG. 26 shows the flow of the accentuated object determining process corresponding to the attentional perspective “MAGNITUDE OF SPECIFIC MEASUREMENT VALUE”.

The management server program 271 performs the same process as in S2301 and S2302 (S2601 and S2602).

The management server program 271 selects a measurement item to be used and a threshold th of a measurement value corresponding to the measurement item (S2603). The measurement item and the threshold th may be determined automatically or specified by the user. The threshold th is a value used to assess a measurement value v such that the measurement value v is a value which is not so problematic as to allow the product related to the measurement value v to be recognized as a defective product, but is preferably paid attention to.

The management server program 271 acquires, from the past record table 700, two steps and four ending times each corresponding to the blank region i (S2604).

The management server program. 271 acquires, for each of the acquired two steps, the measurement value v (the measurement value v corresponding to the measurement item selected in S2603) in each of the intervals between the acquired four ending times (S2605). When there are two or more measurement values, either or any one of the measurement values (e.g., the maximum measurement value) may be used appropriately.

The management server program 271 determines whether or not the measurement value v is larger than the threshold th (S2606). Since the measurement item used herein by way of example is such that, as the measurement value v is larger, a problem is more likely to be encountered, as an example of the determination of whether or not the measurement value is over the threshold, the determination of whether or not v>th is satisfied is used. However, when the measurement item in use is such that, as the measurement value v is smaller, a problem is more likely to be encountered, the determination of whether or not v<th is satisfied may also be made.

When the result of the determination in S2606 is true (Yes in S2606), the management server program 271 determines that the blank region i is the accentuated display target and also determines an accentuation level corresponding to the magnitude (difference between the measurement value v and the threshold th) of the measurement value v (82607). For example, as the measurement value v is larger, the accentuation level (e.g., color shade) is higher.

The management server program 271 determines whether or not i is the last one (maximum value) of the index numbers (S2608). When the result of the determination in S2608 is false (No in S2608), the management server program. 271 increments i by 1 (S2609) and performs S2604.

When the result of the determination in S2608 is true (Yes in S2608), the process is ended.

A plurality of the pairs of the measurement items and the thresholds may also be provided. In this case, the accentuation level of the blank region i may also be based on, instead of or in addition to the magnitude of the measurement value exceeding the threshold, the number of the measurement values exceeding the threshold.

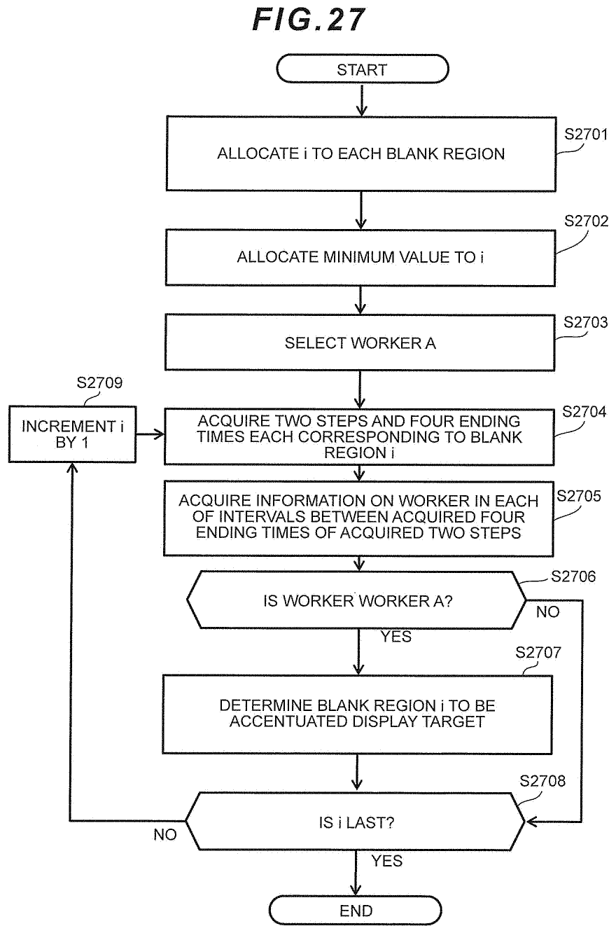

FIG. 27 shows the flow of the accentuated object determining process corresponding to the attentional perspective “WORKER”.

The management server program. 271 performs the same process as in S2301 and S2302 (S2701 and S2702)

The management server program 271 selects a specific worker A (S2703). The worker A may be determined automatically or specified by the user.

The management server program 271 acquires, from the past record table 700, two steps and four ending times each corresponding to the blank region i (S2704).

The management server program 271 acquires, for the acquired two steps, information on the worker who worked in the intervals between the acquired four ending times from the related information 281 (S2705).

The management server program 271 determines whether or not the worker shown by the acquired information is the worker A (S2706).

When the result of the determination in S2706 is true (Yes in S2706), the management server program 271 determines that the blank region i is the accentuated display target (S2707)

The management server program 271 determines whether or not i is the last one (maximum value) of the index numbers (S2708). When the result of the determination in S2708 is false (No in S2708), the management server program 271 increments i by 1 (S2709) and performs S2704.

When the result of the determination in S2708 is true (Yes in S2708), the process is ended.

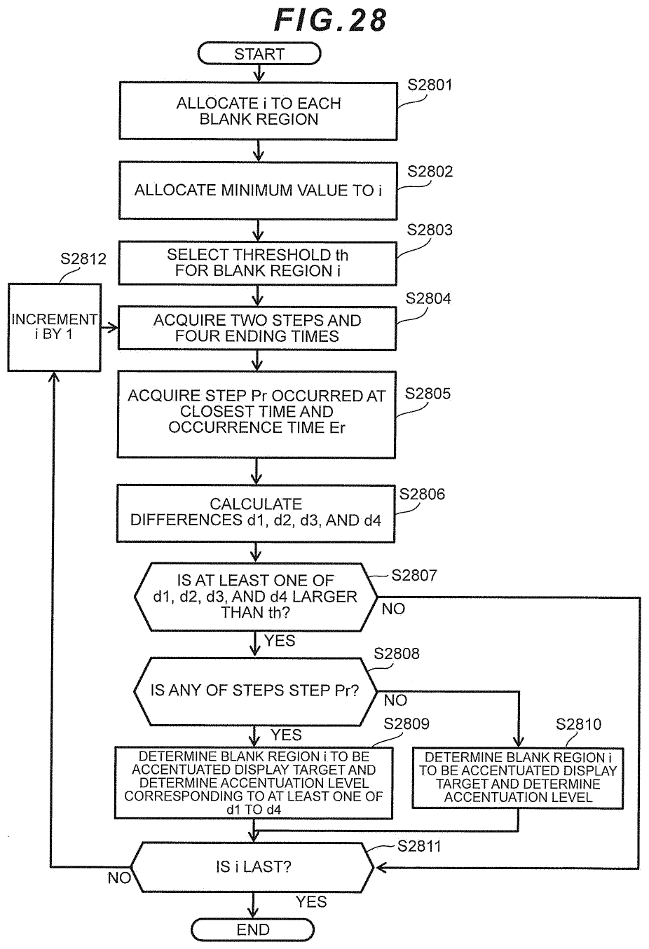

FIG. 28 shows the flow of the accentuated object determining process corresponding to the attentional perspective “RELATIONSHIP WITH OCCURRENCE OF DEFECTIVE PRODUCT”.

The management server program 271 performs the same process as in S2301 and S2302 (S2801 and S2802).

The management server program 271 determines the threshold th of the difference between a time belonging to the blank region i and the occurrence time of a defective product (S2803). The threshold th may be either determined automatically or specified by the user.

The management server program 271 acquires, from the past record table 700, two steps and four ending times earn corresponding to the blank region i (32804).

The management server program 271 retrieves the record of a defective product occurred at a time closest to the acquired four ending times from at least one of the past record table 700 and the related information 281 and acquires a step Pr in which the defective product has occurred and an occurrence time Er of the defective product (S2805). When the corresponding information is not found in S2805, the process may be ended.

The management server program 271 calculates the respective differences (d1, d2, d3, and d4) between the acquired four ending times and the occurrence time Er of the defective product (S2806). The difference d1 is the difference between the ending time of the previous step for the previous product and the occurrence time Er. The difference d2 is the difference between the ending time of the previous step for the subsequent product and the occurrence time Er. The difference d3 is the difference between the ending time of the subsequent step for the previous product and the occurrence time Er. The difference d4 is the difference between the ending time of the subsequent step for the subsequent product and the occurrence time Er. The occurrence time Er may be either previous or subsequent to any of the acquired four ending times. Whether the occurrence time Er is previous or subsequent thereto may also be specified by the user.

The management server program 271 determines whether or not at least one of d1 to d4 is larger than the threshold th (S2807).

When the result of the determination in S2807 is true (Yes in S2807), the management server program 271 determines whether or not either of the two steps acquired in S2804 is the step Pr (S2808).

When the result of the determination in S2808 is true (Yes in S2808), the management server program 271 determines that the blank region i is the accentuated display target and determines the accentuation level of the blank region i on the basis of at least one of d1 to d4 (S2809). For example, as the minimum value of d1 to d4 is smaller, the accentuation level of the blank region i is higher (e.g., color is darker).

When the result of the determination in S2808 is false (No in S2808), the management server program 271 determines that the blank region i is the accentuated display target and sets the accentuation level of the blank region i to a level equal to or lower than the minimum accentuation level that can be adopted in S2809 (S2810). For example, the accentuation level determined in S2810 is the level corresponding to a lightest color.

After S2809 or S2810, the management server program 271 determines whether or not i is the last one (maximum value) of the index numbers (S2811). When the result of the determination in S2811 is false (No in S2811), the management server program 271 increments i by 1 (S2812) and performs S2804.

When the result of the determination in S2811 is true (Yes in S2811), the process is ended.

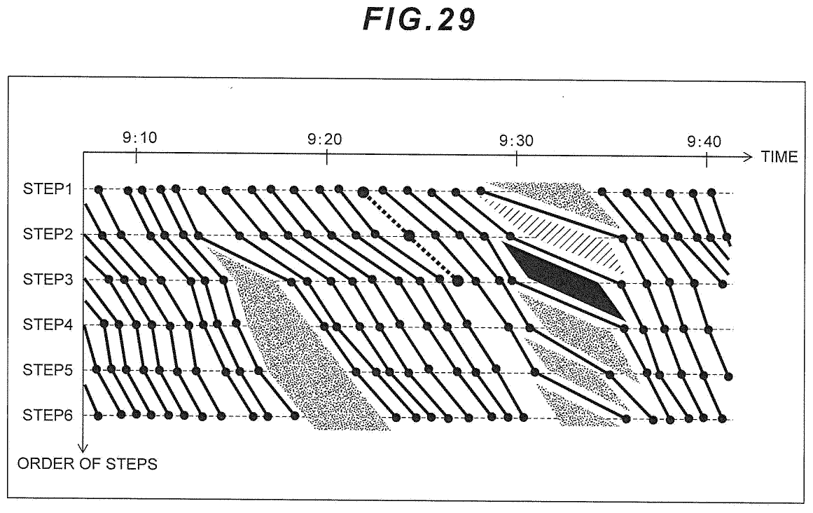

FIG. 29 shows an example of the accentuated display based on the result of the process in FIG. 28.

According to FIG. 29, the blank region belonging to at least one of steps 1 to 3 in which the defective products have occurred and belonging to the ending time closer to the occurrence time of the defective product is subjected to accentuated display at a higher accentuation level (e.g., in a darker color). On the other hand, the blank region belonging to none of steps 1 to 3 in which the defective products have occurred is subjected to accentuated level at a lowest accentuation level.

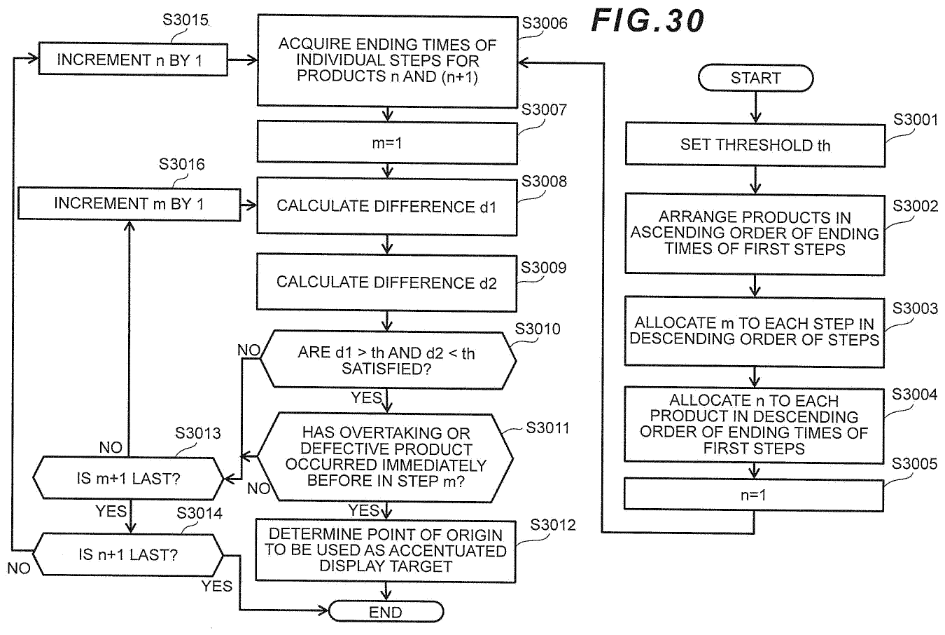

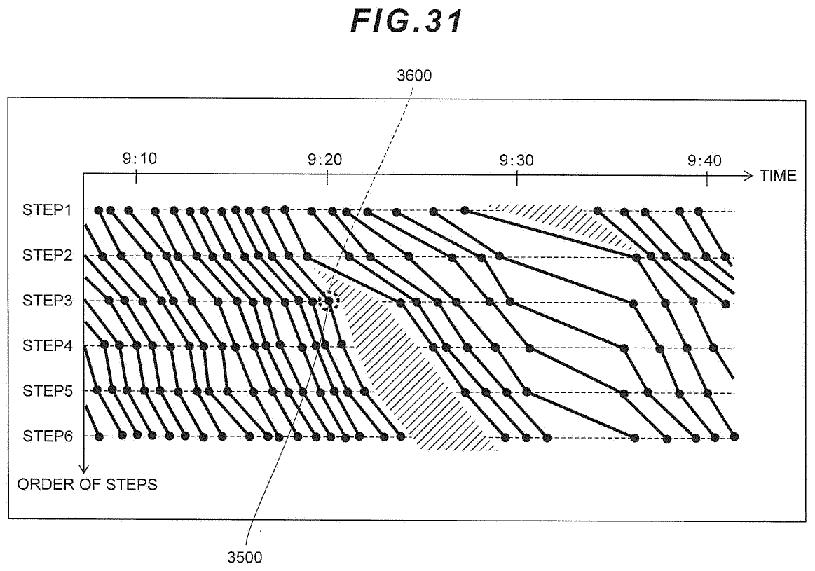

FIG. 30 shows the flow of a process of determining the point of origin of the blank region as the accentuated display target.

This process is an example of the accentuated object determining process included in the display determining process (S1802) in FIG. 18.

The management server program. 271 sets the threshold th of the time difference between consecutive two products (S3001). The threshold th may be either determined automatically or specified by the user.

The management server program. 271 arranges, on the storing portion 252 (e.g., memory), the product IDs of all the products present in the production line during the display target period in ascending order of the ending times of first steps (in chronological order of the ending times of the first steps) (S3002).

The management server program 271 allocates, to each of all the steps in the production line, the index number m showing an ordinal number in descending order of the steps (in reverse order of the steps beginning with the last step) (S3003).

The management server program 271 al locates, to each of the arranged products (each of the product IDs), the index number n showing an ordinal number descending order of the ending times of the first steps (in reverse chronological order beginning with the product for which the ending time of the first step is the last) (S3004).

The management server program 271 allocates 1 to n (S3005).

The management server program 271 acquires, for each of the product n (product having the index number n) and the product (n+1), the ending times of the individual steps (S3006).

The management server program 271 allocates 1 to m (S3007).

The management server program 271 calculates the difference d1 between the ending time of the step m (step having the index number m) for the product n and the ending time of the step m for the product (n+1) (S3008).

The management server program 271 calculates the difference d2 between the ending time of the step (m+1) for the product n and the ending time of the step (m+1) for the product. (n+1) (S3009).

The management server program 271 determines whether or not the difference d1 is larger than the threshold th and the difference d2 is smaller than the threshold th (S3010). To the differences d1 and d2, the threshold th is common herein, but the threshold of the difference d1 and the threshold of the difference d2 may also be set in S3001.

When the result of the determination in S3010 is true (Yes in S3010), the management server program 271 determines whether or not at least one of a defective product and overtaking has occurred immediately before (or immediately after) in the step m on the basis of the past record table 700 (S3011). Note that, when the point of origin of the blank region is detected only from the perspective of the shape of the blank region, S3011 may also be skipped. In the present paragraph, the “immediately before” may refer to a given time before the ending time of the step m for the product (n+1), while the “immediately after” may refer to a given time after the ending time of the step m for the product n. Instead of or in addition to S3011, it may also be possible to determine whether or not requirements provided in association with a perspective other than the shape of the blank region are satisfied.

When the determination result in 53011 is true (Yes in S3011), the management server program 271 detects the point corresponding to the ending time of the step m for the product (n+1) as the point of origin of the blank region and determines that the point of origin is the accentuated display target (S3012). Instead of or in addition to the point corresponding to the ending time of the step m for the product (n±1), the point corresponding to the ending time of the step (m+1) for the product n may also be determined to be the point of origin to be adopted as the accentuated display target.

When the result of the determination in S3011 is false (No in S3011), the management server program 271 determines whether or not m+1 is the last one (maximum value) of the index numbers of the steps (S3013).

When the result of the determination in S3013 is true (Yes in S3013), the management server program 271 determines whether or not n+1 is the last one (maximum value) of the index numbers of the products (S3014). When the result of the determination in S3014 is true (Yes in S3014), the process is ended.

When the result of the determination in S3014 is false (No in S3014), the management server program 271 increments n by I1 (S3015) and performs S3006.

When the result of the determination in S3013 is false (No in S3013), the management server program 271 increments m by 1 (S3016) and performs S3008.

The process of determining the point of origin of the blank region to be adopted as the accentuated display target may also be performed to particularly show, after one or more blank regions as the accentuated display targets (e.g., one or more blank regions each having the accentuation level equal to or larger than the threshold) are determined, which one of the one or more blank regions serves as the point of origin (to reduce the noteworthy blank regions to allow attention to be focused on the blank region serving as the point of origin).

As the process of determining the point of origin of the blank region to be adopted as the accentuated display target, a process shown below may also be adopted instead of the process shown in FIG. 30.

(S30-1) The management server program 271 determines whether or not the one or more blank regions determined to be the accentuated display targets include blank regions unselected in the present process. When the result of the determination in S30-1 is false, the process is ended.

(S30-2) When the result of the determination in S30-1 is true, the management server program 271 selects any unselected blank region. Note that the selection is performed herein in ascending order of time and in ascending order of step. This is intended to specify the first blank region that satisfies requirements on the point of origin in terms of a time and a step.

(S30-3) The management server program 271 determines whether or not the blank region selected in S30-2 satisfies at least Requirement 1 of Requirements 1 and 2 for an arbitrary specification shown below:

(Requirement 1) the upper side of the blank region is less than the threshold and the lower side of the blank region is larger than the threshold; and

(Requirement 2) either overtaking or a defective product has occurred immediately before the blank region.

(S30-4) When the result of the determination in S30-3 is true, the management server program 271 determines that the lower left point of the blank region is the point of origin of the accentuated display target. This is because, when (Requirement 1) shown above is satisfied, there was no abnormal situation in the step corresponding to the upper side of the blank region, but it can be considered that any abnormal situation has started in the subsequent step (step corresponding to the lower side of the blank region) for the previous product y of the product y and the product (y+1) each defining the blank region.

(S30-5) When the result of the determination in S30-3 is false, the management server program 271 returns to S30-1.

FIG. 31 shows an example of the accentuated display of the point of origin of the blank region.

As an example of the accentuated display of a detected point of origin 3500 of the blank region, a circle 3600 surrounding the point of origin is displayed.

### Second Embodiment

A second embodiment will be described. At that time, the description 11 be given mainly of a difference from the first embodiment and a description of points common to the first embodiment is omitted or reduced. Note that, in the following description, an “event” is the event occurred in association with production, which may be, e.g., plan suspension, the facility alert described above, or the like. Also, when the following description is given without discriminating elements of the same type from each other, common signs, which are among reference signs, may be used while, when the following description is given while discriminating elements of the same type from each other, reference signs may be used. For example, when event display objects are not particularly discriminated from each other in the description thereof, the event display objects may be referred to as “event display objects 3201”. On the other hand, when the individual event display objects are discriminated from each other in the description thereof, the individual event display objects may be referred to as an event display object 3201A″, an event display object 3201B″, and the like.

According to the first embodiment, on the diagram chart 170, at least one of the display objects each satisfying the one or more requirements associated with the one or more attentional perspectives are subjected to the accentuated display. However, it may conceivably be difficult to recognize, only from the accentuated display of the display object, the reason for the accentuated display of the display object or the range affected by the reason. It is considered that such a situation may more possibly occur when the display object as the accentuated display target is the blank region.

Accordingly, in the first embodiment, at least one of the vertices of at least the specified blank region of the consecutive blank regions including the specified blank region is used as a key to acquire the related data corresponding to at least the specified blank region included in the consecutive blank regions, and information including at least a portion of the acquired related data is displayed (see, e.g., FIG. 15). As a result, it can be expected to know detailed information related to the blank region. However, the detailed information is information related to the specified blank region and is displayed on a display region other than that for the diagram chart 170. Therefore, a technique which allows the user to easily, holistically, and precisely recognize influence on production and noteworthy points is desired.

Accordingly, in the second embodiment, a display object (event display object) corresponding to the event shown by event data as an example of the related data is displayed in overlapping relation on the diagram chart 170.

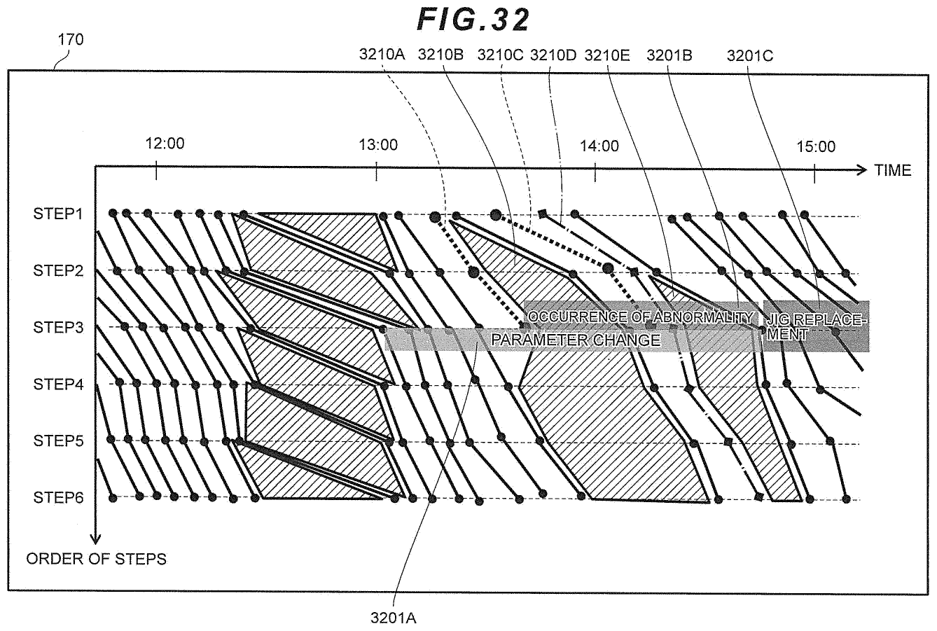

FIG. 32 shows an example of a diagram chart to which event display control according to the second embodiment is applied.

On the diagram chart 170, the event display object 3201 is superimposed. The event display object 3201 is a display object having a length corresponding to the event time block of the event corresponding to the event display object 3201 and parallel with the time axis (an example of the first axis), e.g. band-shaped display object. The event display object 3201 is e.g., a translucent band. The “event time block” may appropriately be a continuous time block. When a given event is temporarily ended and occurs again, for the given event, there may be event data showing an event having an event time block ending at the time at which the given event is temporarily ended and event data showing an event having an event time block starting at the time at which the given event has occurred again.

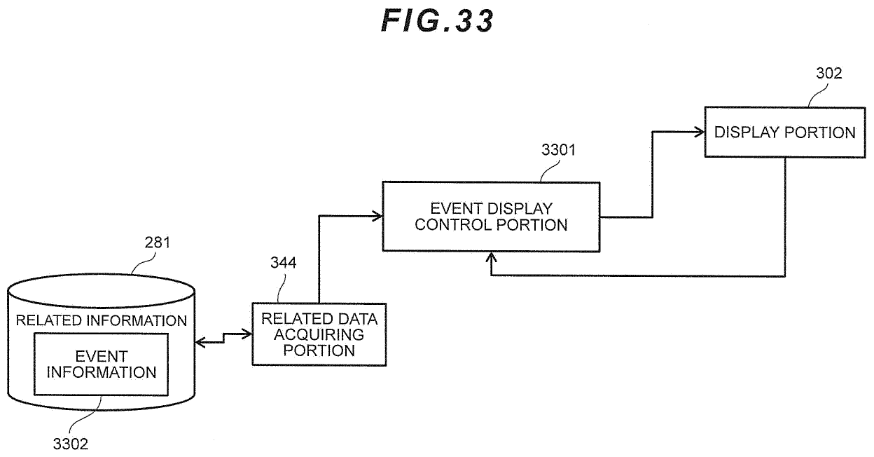

For each event, the event data showing the event has at least an event time block and an event occurrence step. In the event data, the event time block includes, of an occurrence time (e.g., starting time) and an ending time of the event, at least the occurrence time. In the event data, when the ending time of the event time block is undetermined, in an event display control process described later, the ending time of the event time block is determined. The “occurrence step” is the step in which the event has occurred. The related information 281 (see, e.g., FIG. 2) includes event information. 3302 (see, e.g., FIG. 33). The event information 3302 includes event data for each event,

For example, the management server program 271 performs the following process. Specifically, for each of a single or plurality of events among all the events shown by at least any of event data items having the event time block belonging to the display target period in the event information 3302, the management server program 271 superimposes the event display object 3201 having the length corresponding to the event time block of the event and parallel with the time axis on the position on the diagram chart 170 corresponding to the step coincident with the occurrence step of the event and to the event time block of the event. The “event time block belonging to the display target period” means that at least a portion of the event time block (e.g., the occurrence time) overlaps the display target period. An example of the “display target period” is the period specified by the user, as described about the first embodiment. When the “position corresponding to the step coincident with the occurrence step of the event and to the event time block of the event” refers to a position on the time axis (an example of the first axis), the position referred to may be a position corresponding to the occurrence time of the event time block for one end of the event display object and may be a position corresponding to the ending time of the event time block for the other end of the event display object (the ending time may be the ending time specified by the event data or may also be the ending time determined by the management server program 271). When the “position corresponding to the step coincident with the occurrence step of the event and to the event time block of the event” refers to a position on the step axis (an example of the second axis), the position referred to may be a position corresponding to the occurrence step (specifically, e.g., at least one of the position coincident with the occurrence step, a position at a predetermined distance from the coincident position in a positive direction (downward direction in the example in FIG. 32), and a position at the predetermined distance from the coincident position in a negative direction (upward direction in the example in FIG. 32)).

Thus, the information related to the event is superimposed as the display object having the length corresponding to the event time block of the event on the position on the diagram chart 170 corresponding to the step coincident with the occurrence step of the event and to the event time block of the event. This allows the user to browse through the diagram chart 170 and compare the event display object to the display object on the diagram chart 170. As a result, it can be expected to allow the user to recognize which event affects which production step for which product associated with which display object. In other words, it can be expected to facilitate holistic and precise recognition of influence on production and noteworthy points by the user.

Note that the “at least any of event data items having the event time block belonging to the display target period” means that the events as the display targets need not necessarily be all the events shown by all the event data items having the event time blocks belonging to the display target period. For example, at least any of the event data items may be only the event data item corresponding to an accentuated event described later among all the events. Likewise, the “single or plurality of events among all the events shown by at least any of event data items” means that the events as the display targets need not necessarily be all the events shown by at least any of the event data items. For example, when each of all the events shown by at least any of the event data items is the accentuated event, the events as the display targets may also be only the accentuated event having a highest priority or a shortest event time block.

The following is a specific example.

The “single or plurality of events” mentioned above include the one or more accentuated events. Each of the one or more accentuated events is the event to which the accentuated object 3210 as the display object satisfying the one or more requirements associated with the predetermined (e.g., specified) attentional perspective among the one or more attentional perspectives belongs. The “event to which the accentuated object 3210 belongs” is the event having the occurrence step ((e.g., step 3) thereof coincident with any step (e.g., step 3) belonging to the accentuated object 3210 and having the event time block belonging to the execution time of any step belonging to the accentuated object 3210. As a result, it can be expected that the user promptly and precisely recognize which event affects which production step for which product associated with the accentuated object. Note that, according to the example in FIG. 32, among the event display objects 3201A to 3201C, the event display objects 3201A and 3201B are the event display objects of the accentuated events. The “accentuated object” may be the display object actually subjected to the accentuated display such as any of the display objects 3201A to 3201C or may also be the display object which satisfies the one or more requirements each associated with the predetermined attentional perspective among the one or more attentional perspectives but is not determined to be the accentuated display target.

At least one of the “one or more accentuated events” described above is the accentuated event which is among the accentuated events having the same occurrence step and the overlapping event time blocks and which corresponds to at least one of an event having a relatively large number of accentuated objects and an event having a relatively snort event time block. When all the events are adopted as display targets with respective to the same step and the same time, visibility may be degraded. Accordingly, the number of the events which can be displayed with respect to the same step and the same time is preferably limited to N or less (N is an integer of 2 or more). However, since the accentuated event adopted as the display target under the limit is the accentuated event corresponding to at least one of an event having a relative y large number of the accentuated objects 3210 and an event having a relatively short event time block, it can be expected that the accentuated event having a higher degree of influence is preferentially displayed.

The following is a process according to the example shown in FIG. 32. Among the plurality of accentuated events each having step 3 as the occurrence step and each having the event time block including a given time (e.g., 14:00), two accentuated events “PARAMETER CHANGE” and “OCCURRENCE OF ABNORMALITY” have the largest number of the accentuated objects 3210, which is “5”, and the management server program 271 increases the display priorities of the two accentuated events “PARAMETER CHANGE” and “OCCURRENCE OF ABNORMALITY”. As a result, the accentuated events “PARAMETER CHANGE” and “OCCURRENCE OF ABNORMALITY” correspond to N=2 (N is the number of the events that can be displayed with respect to the same step and the same time). This allows the user browsing through the diagram chart 170 to be notified of the event having a higher degree of influence.

When N=1 is satisfied, the management server program 271 is allowed to increase the display priority of the accentuated event “OCCURRENCE OF ABNORMALITY” having the shorter event time block of the two accentuated events “PARAMETER CHANGE” and “OCCURRENCE OF ABNORMALITY” each having the largest number of the accentuated objects 3210, which is “5”. This allows the user to be preferentially notified of the event having a higher degree of influence.

In the example in FIG. 32, the blank region belonging to 12:30 to 13:00 is determined to be the accentuated display target due to the event “PLAN SUSPENSION”. However, since the display object satisfying the one or more requirements each associated with the predetermined attentional perspective such as occurrence of a defective product or occurrence of overtaking does not belong to 12:30 to 13:00, the management server program 271 may lower the display priority of the event “PLAN SUSPENSION”. As a result, according to the example in FIG. 32, the event display object of the event “PLAN SUSPENSION” is not displayed.

Note that the “occurrence step” is the step in which the event has occurred, but one or more steps may also be the “occurrence steps”. In other words, the occurrence step may be one or more steps. Accordingly, a first event (any event) and a second event (any event other than the first event) which have “the same occurrence step” may indicate that at least one of the occurrence steps of the first event and at least one of the occurrence steps of the second event are the same step.

Also, the first event and the second event which have “the overlapping event time blocks” mean that a time block corresponding to at least a portion of the event time block of the first event and a time block corresponding to at least a portion of the event time block of the second event are the same time block. Accordingly, the event time block of one of the first event and the second event may also be completely or partially included in the event time block of the other of the first event and the second event.

In addition, the N (N is an integer of 2 or more) event display objects respectively corresponding to the N accentuated events among the events having the same occurrence step and having the overlapping event time blocks (e.g., the accentuated events, the events other than the accentuated events, or a mixture thereof) are arranged in parallel with the step axis (an example of the second axis) with respect to the same occurrence step. This allows the user browsing through the diagram chart 170 to be notified of the N events occurred in given overlapping time blocks with respect to the same step. Note that, in accordance with at least one of the number of the events adopted as the display targets with respect to the same step and the same time and the display priorities thereof, the height (height of the band) of the event display object of each of the events may also be determined by the management server program. 271. According to the example in FIG. 32, at the time 14:00, there are two events as the display targets. Accordingly, the height of the event display object is adjusted to ½ of the height of the event display object when the event as the display target is one (e.g., at the time 15:00). Specifically, the height of each of the event display object 3201A corresponding to the event “PARAMETER CHANGE” and the event display object 3201B corresponding to the event “OCCURRENCE OF ABNORMALITY” is half the height of the event display object 3201C corresponding to the event “JIG REPLACEMENT”.

According to the event data of any of the one or more accentuated events mentioned above, when the ending time of the event time block of the accentuated event is undetermined and the plurality of events include, in addition to the accentuated event, a subsequent event which is not an accentuated event, has the same occurrence step as the occurrence step of the accentuated event, and has the occurrence time later than the occurrence time of the accentuated event, the management server program 271 sets the ending time of the event time block of the accentuated event to the occurrence time of the subsequent event or to a time earlier than the occurrence time of the subsequent event and superimposes the event display object of the accentuated event and the event display object of the subsequent event on the diagram chart 170. This allows the user browsing through the diagram chart 170 to be notified of the events which may probably have contributed to the absence of the display object determined to be the accentuated display target. According to the example in FIG. 32, the accentuated events are “PARAMETER CHANGE” and “OCCURRENCE OF ABNORMALITY”, while the subsequent event is “JIG REPLACEMENT”. When the ending time of the event time block is undetermined in the event data of each of the accentuated events “PARAMETER CHANGE” and “OCCURRENCE OF ABNORMALITY”, the management server program 271 sets the ending time of each of the accentuated events “PARAMETER CHANGE” and “OCCURRENCE OF ABNORMALITY” to the occurrence time of the subsequent event “JIG REPLACEMENT” or to a time earlier than the occurrence time of the subsequent event “JIG REPLACEMENT”. According to the example in FIG. 32, the display objects (polygonal lines) 3210A, 3210C, and 3210D correspond to the products each subjected to the occurrence of a defective product, and at can be seen that, as a result of performing jig replacement, there is no occurrence of a defective product (defect is eliminated). Note that the product corresponding to the display object (polygonal line) 3210D is the product determined to be defective in the inspection performed after the last step (polygonal line corresponding to such a product will be described in a third embodiment).

The following will more specifically describe the second embodiment.

FIG. 33 shows a portion of an example of functions implemented in the second embodiment including the function associated with the difference from the first embodiment.

The related information 281 includes the event information 3302. The event information 3302 includes event data for each event. The event data is an example of the related data.

Through the execution of the management, server program 271 by the processor portion 253, in addition to the functions described in the first embodiment, an event display control portion 3301 is implemented. The event display control portion 3301 may appropriately be the function included in the control portion 303 (see FIG. 3).

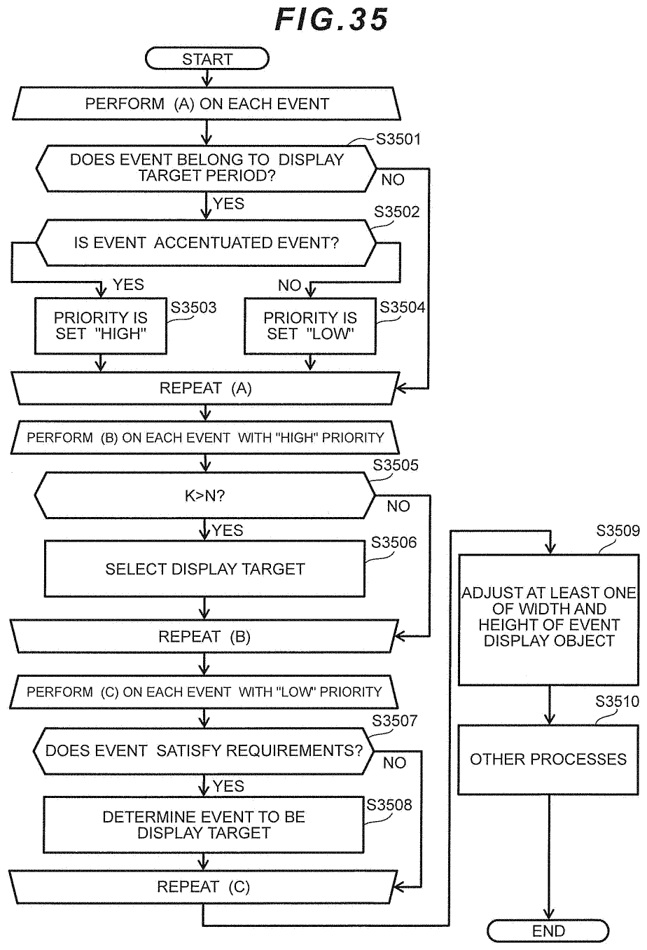

The event display control portion 3301 performs an event display control process (FIG. 35). Specifically for example, the event display control portion 3301 acquires event data from event information 3302 through the related data acquiring portion 344. Also, for example, the event display control portion 3301 specifies the accentuated object since the accentuated object satisfies the one or more requirements each associated with the predetermined attentional perspective among the one or more attentional perspectives through the display portion 302 (and/or on the basis of one or more functions which are other than the display portion 302 and detect the display objects satisfying the one or more requirements associated with the one or more attentional perspectives). Al so, for example, the event display control portion 3301 determines the event as the display target and notifies the display portion 302 of the event display object of the determined event and the display position thereof. In response to the notification, the display portion 302 displays the event display object 3201 in overlapping relation on the diagram chart 170.

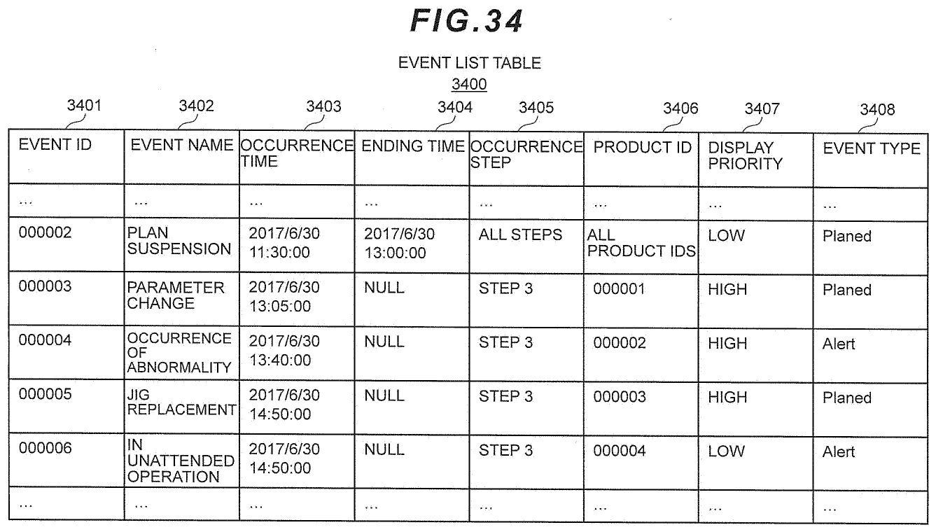

FIG. 34 shows an event list table.

An event list table 3400 is an example of the table included in the event information 3302. The event list table 3400 has a record for each event. Each record stores information such as an event ID 3401, an event name 3402, an occurrence time 3403, an ending time 3404, an occurrence step 3405, a product ID 3406, a display priority 3407, and an event type 3408. Each record corresponds to the event data.

The event ID 3401 shows the ID of an event. The event name 3402 shows the name of the event. The occurrence time 3403 shows the time at which the event has occurred. The ending time 3404 shows the time at which the event is ended. “Null” means that the ending time of the event is undetermined. The occurrence step 3405 shows the step in which the event has occurred. The product ID 3406 shows the ID of the product associated with the event. The display priority 3407 shows the display priority of the event. The event type 3408 shows the event type to which the event belongs. “Planed” means normality, while “Alert” means abnormality.

According to the example in FIG. 34, the display priority has “HIGH” and “LOW” two levels. However, the display priority may also have more than two levels. The level of the display priority of the event may also depend on the event type.

FIG. 35 shows the flow of an event display control process.

The management server program 271 performs 03501 to S3504 for each event (each record in the event list table 3400) (loop (A)) The following will use one of the events as an example (“target event” in S3501 to S3504).

The management server program 271 determines whether or not at least one of the occurrence time 3403 and the ending time 3404 of the target event belongs to the display target period (S3501) When the result of the determination in S3501 is false (No in S3501), the target event is not determined to be a display target.

When the result of the determination in S3501 is true (Yes in S3501), the management server program 271 determines whether or not the target event is the accentuated event (event to which the accentuated object satisfying the one or more requirements each associated with the predetermine attentional perspective among the one or more attentional perspectives belongs) (S3502). The accentuated event mentioned herein may appropriately be the event to which the display object defined as the accentuated object since the relationship with at least one of the time and the step of target occurrence satisfies a predetermined requirement belongs. The target occurrence is at least one of the occurrence of overtaking, the occurrence of a defective product, the occurrence of rework, the occurrence of an exceeded lead time, and the occurrence of unevenness. The accentuated object mentioned herein may also be limited to the blank region.

When the result of the determination in S3502 is true (Yes in S3502), the management server program 271 sets the display priority 3407 of the target event to the “HIGH” level (53503). On the other hand, when the result of the determination in S3502 is false (No in S3502), the management server program 271 sets the display priority 3407 of the target event to the “LOW” level (S3501)

The management server program 271 performs S3505 and S3506 on each of the events having the “HIGH”-level display priority 3407 among the events belonging to the display target period (i.e., each of the accentuated events) (loop (B)). The following will use one of the events as an example (“target event” in S3505 and S3506).

The management server program 271 determines whether or not the number K of the accentuated events having the same occurrence step 3405 of the target event and the overlapping event time blocks of the target event is larger than N (the number of the events that can be displayed with respect to the same step and the same time) (S3505).

When the result, of the determination in S3505 is true (Yes S3505), the management server program 271 selects N or less accentuated events from among the K accentuated events (S3506). Specifically, for example, the management server program 271 selects, from among the K accentuated events, the accentuated event corresponding to at least one of the event having a relatively large number of the accentuated objects and the event having a relative short event time block.

Note that, when the result of the determination in S3505 is false (No in S3505), S3506 is skipped. In the loop (B), the accentuated event already included in the K accentuated events in S3505 previously performed need not be selected as the target event.

The management server program 271 perform S3507 and S3508 for each of the events having the “LOW”-level display priority 3407 among the events belonging to the display target period (i.e. each of the events other than the accentuated events) (loop (C)). The following will use one of the events as an example (“target event” in S3507 and S3508).

The management server program 271 determines whether or not the target event satisfies a predetermined requirement (S3507). The “predetermined requirement” mentioned in the present paragraph may be the “subsequent event having the same occurrence step as the occurrence step of the accentuated event determined to be the display target in S3506 (e.g., the accentuated event (e.g., “Null”) having the latest ending time 3404 among the N or less accentuated events) and having the occurrence time later than the occurrence time of the accentuated event”.

When the result of the determination in S3507 is true (Yes in S3507), the management server program 271 determines that the target event is the display target (S3508).

Note that when the result of the determination in S3507 is false (No in S3507), S3508 is skipped.

As necessary, the management, server program 271 adjusts at last one of the width and height of the event display object of each of the events determined to be the display targets (S3509). For instance, an example of the case which needs the adjustment may appropriately be at least one of cases shown below.

The case where the number of the event display objects with respect to the same step and the same time is two or more. In this case, the management server program 271 determines the height of each of the event display objects in accordance with at least one of the number of the events determined to be the display targets with respect to the same step and the same time and the display priorities thereof.

The case where the ending time 3404 of the event as the display target is “Null”. In this case, the management server program 271 sets the ending time for the event display object of the event to the ending time of the display target period or to the occurrence time (or a time previous thereto) of the subsequent event.

The case where the respective event time blocks of the events of the same type are overlapping with respect to the same step. In this case, the management server program 271 sets the occurrence time of the latter-stage one of these events as the ending time (or a time previous thereto) of the ending time of the former-stage one of these events.

Finally, the management server program 271 performs other processes (83510) The other processes include, e.g., a process in which the event display control portion 3301 (see FIG. 33) notifies the display portion 302 of the event display object and the display position thereof for each of the events determined to be the display targets. The other processes also include at least one of processes shown below which are:

the process in which the UI (e.g., a right click menu or a button) used by the user when the user requests the display of the event display object is set onto the display screen of the diagram chart 170; and

the process in which the UT (e.g., a tool chip) when the user requests the details of the event is set.

The foregoing is the flow of the event display control process. Note that the event display control process may be, e.g., the process included in S1802 (display determining process) in FIG. 18 or a process other than S1802. In the latter case, the event display control process also includes display (drawing) of the event display object determined to be the display target in overlapping relation on the diagram chart 170, which is performed by the management server program 271.

### Third Embodiment

A third embodiment will be described. At that time, the description will be given mainly of a difference from the first and second embodiments and a description of points common to the first and second embodiments is omitted or reduced.

The display object subjected to the accentuated display is at least one of (a) to (e) shown below.

(a) A polygonal line corresponding to a product which is subjected to the occurrence of overtaking and which is at least one of products (a1) and (a2) shown below

(a1) at least one of one or more products which are loaded in a production line later than a given product but have at least one step the execution time of which is earlier than that for the given product, and

(a2) the given product.

(b) A polygonal line corresponding to a product which is subjected to the occurrence of a defective product and which corresponds to at least one of a product for which any step has no execution time and a product determined to be defective in an inspection performed after the last step (the polygonal line corresponding to the former product subjected to the occurrence of a defective product is, e.g., each of the polygonal lines 3210A and 3210C in FIG. 32, while the polygonal line corresponding to the latter product subjected to the occurrence of a defective product is, e.g., the polygonal line 3210D in FIG. 32).

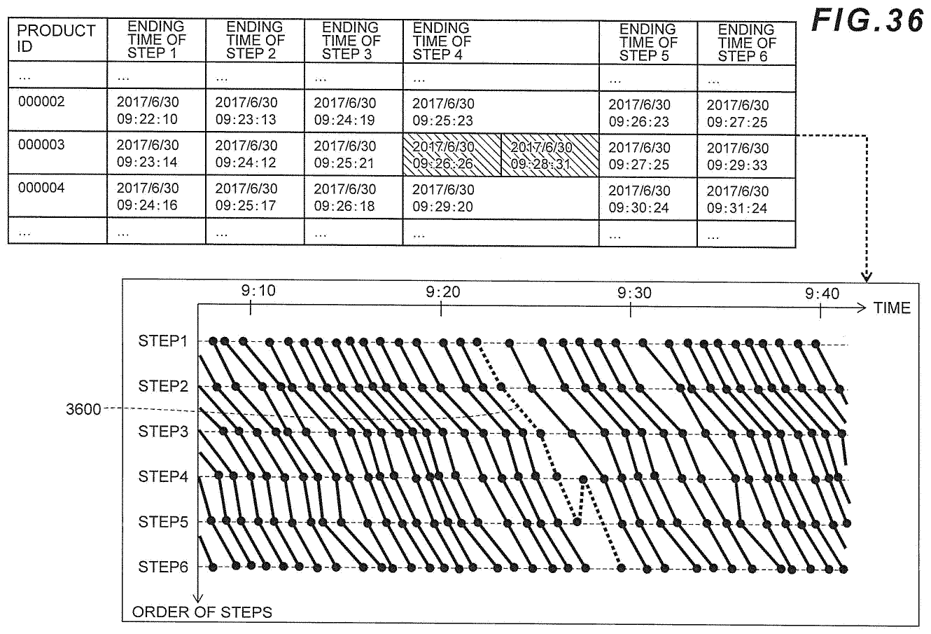

(c) A polygonal line corresponding to a product subjected to the occurrence of rework, which is a product for which there are two or more execution times of the same step due to the occurrence of a restart, an example of which is the polygonal line 3600 in FIG. 36.

(d) A polygonal line corresponding to a product subjected to the occurrence of an exceeded lead time, which is a product for which a lead time as a period from the starting of all or at least one of steps to the ending thereof exceeds a given period.

(e) A polygonal line corresponding to a product subjected to the occurrence of unevenness, which is a product for which the difference between the execution time of a first step as any step and the execution time of a second step as any step other than the first step is longer or shorter by a given value or more than a take time between the first step and the second step.

The management server program 271 can specify, from the past record information 140, not only the occurrence of overtaking and the occurrence of a defective product, but also any of the occurrence of rework, the occurrence of an exceeded lead time, and the occurrence of unevenness. For example, as shown by way of example in FIG. 36, a product “000003” for which there are two or more ending times of the same step may be detected as the product subjected to the occurrence of rework. Also, for example, a product for which the period from the starting time of a step X (any step) to the ending time of a step Y (the same as or subsequent to the step X) exceeds a given period may be detected as the product subjected to the occurrence of an exceeded lead time (at that time, in the past record information 140, in addition to the ending time of each step for each product, the starting time thereof may also be recorded). Also, for example, a product for which the difference between the ending time of the first step and the ending time of the second step is longer or shorter by a given value or more than the take time between the first step and the second step (e.g., average difference for a given number of products (average of the differences between the ending times of the first step and the ending times of the second step)) may also be detected as the product subjected to the occurrence of unevenness.

Each of the single or plurality of blank regions to be subjected to the accentuated display may be the blank region for which the relationship with at least one of the time and the step of target occurrence satisfies the predetermined requirement (e.g., the blank region having any vertex to which both of the time and the step of target occurrence correspond), the target occurrence being at least one of the occurrence of product overtaking, the occurrence of a defective product, the occurrence of rework, the occurrence of an exceeded lead time, and the occurrence of unevenness.

Also, for example, it may also be possible that, with regard to the occurrence of a defective product., a plurality of defect types and to which defect type which defect content belongs are defined in advance (e.g., a table showing the relationships between the defect types and the defect contents is included in the related information 281), and the management server program 271 sets the accentuation level of the polygonal line corresponding to the product subjected to the occurrence of a defective product to an accentuation level in accordance with the defect type to which the defect content of the occurrence of a defective product belongs.

While some of the embodiments of the present invention have been described above, these embodiments are examples for describing the present invention and are not intended to limit the scope of the present invention to these embodiments. The present invention can be implemented even in various other forms.

For example, instead of or in addition to the accentuation level of the blank region, the accentuation level of the display object of another type (e.g., at least a portion of the polygonal line) may also be a level in accordance with at least one of the degree of importance of at least one of the one or more attentional perspectives on the basis of which the display object is determined to be the accentuated display target, the number of the attentional perspectives on the basis of which the display object is determined to be the accentuated display target, and a value acquired with respect to the display object on the basis of the attentional perspective.

Also, for example, the process of determining the display object to be eliminated from the accentuated display targets may be applied appropriately to the display object of another type instead of or in addition to the blank region.

### REFERENCE SIGNS LIST

100 Production management supporting system

1. A production management supporting system, comprising:
an interface portion including one or more interfaces;
a storing portion including one or more memories, the storing portion storing past record information including information as a past record which shows, for each product loaded in a production line in which a plurality of steps are performed, an execution time of each of the steps; and
a processor portion coupled to the interface portion and to the storing portion, wherein
the processor portion
analyzes the past record information on the basis of one or more attentional perspectives to detect, among objects displayed on a diagram chart showing a production situation, display objects each satisfying one or more requirements associated with the one or more attentional perspectives, and
wherein the diagram chart is a polygonal line graph having a first axis and a second axis perpendicular to the first axis,
wherein the first axis corresponds to time,
wherein the second axis corresponds to the steps,
wherein the diagram chart has a polygonal line for each product for which at least one of the plurality of steps has the execution time belonging to a display target period, and
wherein a point on each polygonal line corresponds to the step and to the execution time of the step,
performs accentuated display of at least one of the detected display objects.

2. The production management supporting system according to claim 1, wherein an accentuation level of the display object subjected to the accentuated display corresponds to at least one of items (A) to (C):
(A) a degree of importance of at least one of the one or more attentional perspectives on the basis of which the display object is determined to be an accentuated display target;
(B) the number of the attentional perspectives on the basis of which the display object is determined to be the accentuated display target; and
(C) a value acquired with respect to the display object on the basis of the attentional perspectives.

3. The production management supporting system according to claim 2, wherein
the processor portion provides a UI (user interface) which receives a specification of at least one of the attentional perspectives or the degree of importance thereof, and
at least one of the one or more attentional perspectives is the attentional perspective specified via the UI or includes the degree of importance of the attentional perspective.

4. The production management supporting system according to claim 1, wherein the processor portion eliminates, from an accentuated display target, the display object associated with the step or product having the execution time belonging to a plan suspension period.

5. The production management supporting system according to claim 1, wherein the display object subjected to the accentuated display is at least one of polygonal lines (a) to (e) shown below:
(a) a polygonal line corresponding to a product which is subjected to occurrence of overtaking and which is at least one of products (a1) and (a2) shown below
(a1) at least one of one or more products which are loaded in the production line later than a given product but have at least one step the execution time of which is earlier than that for the given product, and
(a2) the given product;
(b) a polygonal line corresponding to a product which is subjected to occurrence of a defective product and which corresponds to at least one of a product for which any step has no execution time and a product determined to be defective in an inspection performed after the last step;
(c) a polygonal line corresponding to a product subjected to occurrence of rework, which is a product for which there are two or more execution times of the same step due to occurrence of a restart;
(d) a polygonal line corresponding to a product subjected to occurrence of an exceeded lead time, which is a product for which a lead time as a period from starting of all or at least one of the steps to ending thereof exceeds a given period; and
(e) a polygonal line corresponding to a product subjected to occurrence of unevenness, which is a product for which a difference between the execution time of a first step as any step and the execution time of a second step as any step other than the first step is longer or shorter by a given value or more than a take time between the first step and the second step.

6. The production management supporting system claim 1, wherein
the display object that can be determined to be an accentuated display target on the diagram chart is one or more blank regions each sandwiched between a polygonal line corresponding to a product y (a y-th product (y is a natural number)) and a polygonal line corresponding to a product (y+1), and
each of the blank regions is a region bounded by four points (p1) to (p4) shown below:
(p1) the point corresponding to a step x (an x-th step (x is a natural number)) and the execution time of the step x for the product y;
(p2) the point corresponding to a step (x+1) and the execution time of the step (x+1) for the product y;
(p3) the point corresponding to the step x and the execution time of the step x for the product (y+1); and
(p4) the point corresponding to the step (x+1) and the execution time of the step (x+1) for the product (y+1).

7. The production management supporting system according to claim 6, wherein the processor portion receives a specification of any blank region subjected to the accentuated display from a user, acquires, in response to the specification, related data related to at least the specified blank region included in consecutive blank regions from related information related to the past record and displays the acquired related data, the consecutive blank regions being one or more blank regions which are sandwiched between two polygonal lines between which the specified blank region is sandwiched, are each determined to be the accentuated display target, and are consecutive along a direction of the second axis, the acquisition of the related data being performed using, as a key, information showing at least one vertex of at least the specified blank region included in the consecutive blank regions.

8. The production management supporting system according to claim 6, wherein the display object subjected to the accentuated display is the blank region having an area equal to or larger than a predetermined threshold.

9. The production management supporting system according to claim 6, wherein
the display object subjected to the accentuated display is the blank region having a value equal to or larger than a predetermined threshold, the value being obtained by applying a weight to an area of the blank region, and
the weight of the blank region is based on at least one of (r1) to (r4) shown below:
(r1) a degree of importance of the attentional perspective of the area of the blank region;
(r2) related data corresponding to the blank region;
(r3) the number of other attentional perspectives on the basis of which the blank region is determined to be the accentuated display target; and
(r4) the degrees of importance of other attentional perspectives on the basis of which the blank region is determined to be the accentuated display target.

10. The production management supporting system according to claim 6, wherein the display object subjected to the accentuated display is the blank region for which a measurement value obtained between the execution times satisfies a predetermined requirement.

11. The production management supporting system according to claim 6, wherein
the display object subjected to the accentuated display is a single or plurality of blank regions for which a relationship with at least one of a time and a step of target occurrence satisfies a predetermined requirement, the target occurrence being at least one of occurrence of product overtaking, occurrence of a defective product, occurrence of rework, occurrence of an exceeded lead time, and occurrence of unevenness,
a product subjected to the occurrence of product overtaking is at least one of a given product and at least one of one or more products which are loaded in the production line later than the given product but have at least one step the execution time of which is earlier than that for the given product,
a product subjected to the occurrence of a defective product corresponds to at least one of a product for which any step has no execution time and a product determined to be defective in an inspection performed after the last step,
a product subjected to the occurrence of rework is a product for which there are two or more execution times of the same step due to occurrence of a restart,
a product subjected to the occurrence of an exceeded lead time is a product for which a lead time as a period from starting of all or at least one of the steps to ending thereof exceeds a given period, and
a product subjected to the occurrence of unevenness is a product for which a difference between the execution time of a first step as any step and the execution time of a second step as any step other than the first step is longer or shorter by a given value or more than a take time between the first step and the second step.

12. The production management supporting system according to claim 11, wherein, among the single or plurality of blank regions, the blank region belonging to the step to which the target occurrence belongs has an accentuation level in accordance with a difference between the time of the target occurrence and the execution time to which the blank region belongs.

13. The production management supporting system according to claim 6, wherein the processor portion performs the accentuated display of a predetermined one of four points of a blank region as a point of origin of the blank region, the blank region having the earliest step and the earliest execution time or having the latest step and the latest execution time among blank regions serving as the detected display objects and satisfying requirements (w1) and (w2) which are arbitrary specification requirements:
(w1) an upper side of the blank region is less than a threshold and a lower side of the blank region is larger than the threshold; and
(w2) at least one of the product overtaking and the defective product has occurred before a given time before the execution time.

14. The production management supporting system according to claim 1, wherein
event information includes, for each event, event data having information showing an event time block and an occurrence step, the event time block including at least occurrence time among the occurrence time and an ending time of the event, the occurrence step being a step in which the event has occurred, and the processor portion superimposes, for each of a single or plurality of events among all the events shown by at least any event data included in the event information and having the event time block belonging to the display target period, an event display object which is a display object having a length corresponding to the event time block of the event and parallel with the first axis, on a position on the diagram chart corresponding to a step coincident with the occurrence step of the event and to the event time block of the event.

15. The production management supporting system according to claim 14, wherein
the single or plurality of events include one or more accentuated events,
each of the one or more accentuated events is an event to which an accentuated object as a display object satisfying the one or more requirements each associated with a predetermined attentional perspective among the one or more attentional perspectives belongs, and
the event to which the accentuated object belongs is an event having the occurrence step coincident with any step belonging to the accentuated object and having the event time block belonging to the execution time of any step belonging to the accentuated object.

16. The production management supporting system according to claim 15, wherein at least one of the one or more accentuated events is an accentuated event which is among the accentuated events having the same occurrence step and overlapping event time blocks and which corresponds to at least one of an event having a relatively large number of the accentuated objects and an event having the relatively short event time block.

17. The production management supporting system according to claim 14, wherein N event display objects (N is an integer of 2 or more) individually corresponding to N events among the accentuated events having the same occurrence step and overlapping event time blocks are arranged in parallel with the second axis with respect to the same occurrence step.

18. The production management supporting system according to claim 15, wherein, according to the event data of any of the one or more accentuated events, when the ending time of the event time block of the accentuated event is undetermined and the plurality of events include, in addition to the accentuated event, a subsequent event which is other than the accentuated event, has the same occurrence step as the occurrence step of the accentuated event, and has the occurrence time later than the occurrence time of the accentuated event, the processor portion
sets the ending time of the event time block of the accentuated event to the occurrence time of the subsequent event or to a time previous thereto, and
superimposes the event display object of the accentuated event and the event display object of the subsequent event on the diagram chart.

19. A production management supporting method, comprising the steps of:
analyzing past record information including information as a past record showing, for each product loaded in a production line in which a plurality of steps are performed, an execution time of each of the steps on the basis of one or more attentional perspectives to detect, from among objects displayed on a diagram chart showing a production situation, display objects each satisfying one or more requirements associated with the one or more attentional perspectives; and
performing accentuated display of at least one of the detected display objects, wherein
the diagram chart is a polygonal line graph having a first axis and a second axis perpendicular to the first axis,
the first axis corresponds to time,
the second axis corresponds to the steps,
the diagram chart has a polygonal line for each product for which at least one of the plurality of steps has the execution time belonging to a display target period, and
a point on each polygonal line corresponds to the step and to the execution time of the step.

20. A computer program for causing a computer to perform the steps of:
analyzing past record information including information as a past record showing, for each product loaded in a production line in which a plurality of steps are performed, an execution time of each of the steps on the basis of one or more attentional perspectives to detect, from among objects displayed on a diagram chart showing a production situation, display objects each satisfying one or more requirements associated with the one or more attentional perspectives; and
performing accentuated display of at least one of the detected display objects, wherein
the diagram chart is a polygonal line graph having a first axis and a second axis perpendicular to the first axis,
the first axis corresponds to time,
the second axis corresponds to the steps,
the diagram chart has a polygonal line for each product for which at least one of the plurality of steps has the execution time belonging to a display target period, and
a point on each polygonal line corresponds to the step and to the execution time of the step.
